(19) United States
(12) Patent Application Publication
(10) Pub. No.: US 2016/0109999 A1
(43) Pub. Date: Apr. 21, 2016

(54) PROVIDING METHOD FOR INPUTTING AND ELECTRONIC DEVICE

(71) Applicant: Samsung Electronics Co., Ltd., Suwon-si (KR)

(72) Inventors: Hoe Joo LEE, Gumi-si (KR); Ji Woo LEE, Gumi-si (KR)

(21) Appl. No.: 14/885,324

(22) Filed: Oct. 16, 2015

(30) Foreign Application Priority Data
Oct. 21, 2014 (KR) 10-2014-0142802

(51) Int. Cl. G06F 3/041; G06F 3/0484; G06F 3/0488

(52) U.S. Cl. CPC G06F 3/0412; G06F 3/04883; G06F 3/04842

(57) ABSTRACT

A mobile electronic device is provided. The mobile electronic device includes a display configured to display at least one object, at least one hardware component disposed in an area other than an area of the display, a guard touch area disposed within a distance from the at least one hardware component, wherein a touch event is generated when the guard touch area is touched, and a processor configured to control the display to display an object associated with operation of one or more of the at least one hardware component based on the touch event.

### CROSS-REFERENCE TO RELATED APPLICATION(S)

This application claims the benefit under 35 U.S.C. §119(a) of a Korean patent application filed on Oct. 21, 2014 in the Korean Intellectual Property Office and assigned Serial number 10-2014-0142802, the entire disclosure of which is hereby incorporated by reference.

### TECHNICAL FIELD

The present disclosure relates to an input function of an electronic device.

### BACKGROUND

In general, existing electronic devices support an input function in relation to operation of user functions. The electronic devices include, for example, at least one physical key button and a touch panel (e.g., a touch screen) disposed to correspond to a display. A user may generate a user input by touching the touch screen or pressing the physical key button.

In the electronic devices, various hardware components are arranged in an area other than a display area. For example, the hardware components may include a module for supporting a specific function, such as an audio jack or a speaker for outputting audio data to a connected external device, or a physical key button or a physical key related to generation of an input event (or touch event). Furthermore, the electronic devices include a home button disposed at a bezel area that surrounds a display or a side key (e.g., a power key button) disposed at a side part. The electronic devices may process various input signals according to a method of manipulating one physical key button. For example, the power key button of the electronic devices is configured to turn on/off a display in response to a tap motion. Furthermore, the power key button is configured to turn on/off the electronic devices in response to a long-press motion. The home button of the electronic devices is configured to perform a function of turning on/off a display or switching a current screen to a home screen in response to a tap motion. Furthermore, the home button is configured to perform a specified function in response to a long-press motion.

As described above, the existing electronic devices enable configuration for execution of a specific function through a hardware component disposed at an area other than a display area. However, a user may not be exactly aware of what hardware component is associated with what function, so that the efficiency of the hardware component may decrease. Moreover, since the hardware component of the electronic devices is fixed, the user is unable to operate a specific hardware component function at a specific location desired by the user.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an input supporting method for allowing a user to more intuitively understand and operate a function related to a specific hardware component by providing an object including a function item related to the hardware component, and an electronic device supporting the method.

Another aspect of the present disclosure is to provide an input supporting method for changing an operation position of a function item related to the hardware component as intended by a user regardless of a position of the fixed hardware component, and an electronic device supporting the method.

In accordance with an aspect of the present disclosure, an electronic device is provided. The electronic device includes a display configured to display at least one object, at least one hardware component disposed in an area other than an area of the display, a guard touch area disposed within a distance from the at least one hardware component, wherein a touch event is generated when the guard touch area is touched, and a processor configured to control the display to display an object associated with operation of one or more of the at least one hardware component based on the touch event.

In accordance with another aspect of the present disclosure, an input supporting method is provided. The input supporting method includes receiving a touch event at a guard touch area disposed within a distance from at least one hardware component disposed in an area other than an area of a display of a mobile electronic device, and displaying on the display an object associated with operation of one or more of the at least one hardware component based on the touch event.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a schematic diagram illustrating an exterior of an electronic device according to various embodiments of the present disclosure;

FIG. 2 is a diagram illustrating a touch panel of an electronic device according to various embodiments of the present disclosure;

FIG. 3 is a diagram illustrating arrangement of guard touch portions according to various embodiments of the present disclosure;

FIG. 4 is a diagram illustrating an electronic device and an operation environment thereof according to various embodiments of the present disclosure;

FIG. 5 is a diagram illustrating a function processing module according to various embodiments of the present disclosure;

FIG. 6 illustrates an electronic device operating method related to hardware-based touch area operation according to various embodiments of the present disclosure;

FIG. 7 illustrates an electronic device operating method related to object operation based on hardware state information according to various embodiments of the present disclosure;

FIG. 8 illustrates an electronic device operating method related to editing of an object according to various embodiments of the present disclosure;

FIG. 9 is a diagram illustrating a shape of an object according to various embodiments of the present disclosure;

FIG. 10 is a diagram illustrating an object output and a function item output according to various embodiments of the present disclosure;

FIG. 11 is a diagram illustrating operation of a function item according to various embodiments of the present disclosure;

FIG. 12 is a diagram illustrating addition of a function item according to various embodiments of the present disclosure;

FIG. 13 is a diagram illustrating operation of a specific object according to various embodiments of the present disclosure;

FIG. 14 is a diagram illustrating adjustment of a position of an object according to various embodiments of the present disclosure;

FIG. 15 is a diagram illustrating an object editing function according to various embodiments of the present disclosure; and

FIG. 16 is a diagram illustrating another example of output of a specified object for each hardware component information according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include,” “comprise,” “including,” or “comprising” used herein indicates disclosed functions, operations, or existence of elements but does not exclude other functions, operations or elements. It should be further understood that the term “include”, “including”, “comprise”, “comprising”, “have”, or “having” used herein specifies the presence of stated features, numbers, operations, elements, components, or combinations thereof but does not preclude the presence or addition of one or more other features, numbers, operations, elements, components, or combinations thereof.

The meaning of the term “or” or “at least one of A and/or B” used herein includes any and all combinations of words listed together with the term. For example, the wording “A or B” or “at least one of A and/or B” may indicate A, B, or both A and B.

The terms such as “first”, “second”, and the like used herein may refer to various elements of various embodiments of the present disclosure, but do not limit the elements. For example, such terms do not limit the order and/or priority of the elements. Furthermore, such terms may be used to distinguish one element from another element. For example, a first user device and a second user device indicate different user devices. For example, without departing the scope of the present disclosure, a first element may be named as a second element, and similarly, a second element may be named as a first element.

It should be understood that when an element is referred to as being “connected” or “coupled” to another element, it can be directly connected or coupled to the other element or intervening elements may be present between the element and the other element. On the contrary, it should be understood that when an element is referred to as being “directly connected” or “directly coupled” to another element, there are no intervening elements between the element and the other element.

The terms used herein, including technical or scientific terms, have the same meanings as understood by those skilled in the art unless otherwise defined herein. Commonly-used terms defined in a dictionary should be interpreted as having meanings that are the same as contextual meanings defined in the related art, and should not be interpreted in an idealized or overly formal sense unless otherwise defined explicitly.

An input function of an electronic device according to various embodiments of the present disclosure will be described with reference to the accompanying drawings.

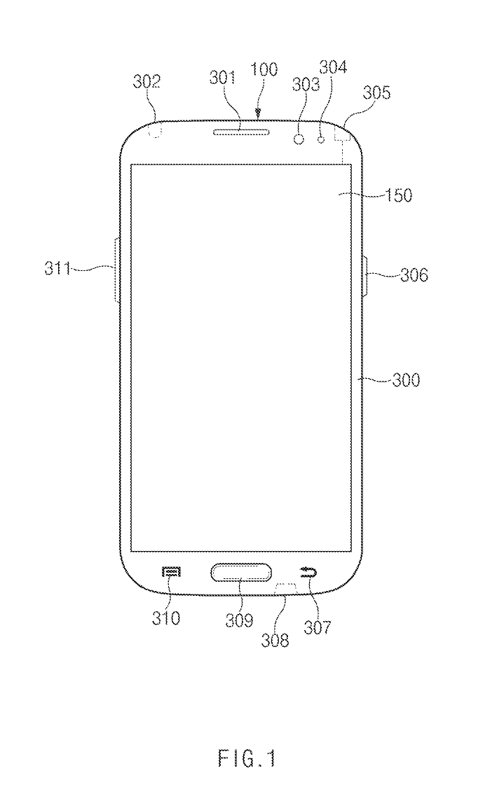

FIG. 1 is a schematic diagram illustrating an exterior of an electronic device according to various embodiments of the present disclosure.

Referring to FIG. 1, an electronic device 100 may include a display 150 and a case 300 surrounding the display 150.

The display 150 may output various screens related to the electronic device 100. For example, the display 150 may provide at least one function screen (e.g., a lock screen, a home screen, a standby screen, or the like) supported by the electronic device 100.

According to various embodiments of the present disclosure, the display 150 may output an object corresponding to an input event (or touch event) if the input event occurs on a guard touch area (e.g., an area in which guard touch portions are arranged, wherein the guard touch portions are provided to at least one of a bezel (a part of a front area disposed at an edge or a border of the display 150, associated with generating touch event when touching) disposed at an area other than an area of the display 150, a side part connected to the bezel and disposed at a side of the electronic device 100, or a rear part connected to the side part and disposed at a rear of the electronic device 100) disposed within a certain distance (or specific range) from at least one hardware component. The display 150 may include a display area to which the object is output. The guard touch area may include, for example, a non-display area of the display 150 and the area other than the area of the display 150. The object may include at least one function item (including at least one of a text or an image, wherein the text or the image may indicate or suggest a hardware-related function) related to a hardware component. The object may be moved on the display 150, may be changed in shape, or may be removed according to at least one input event (e.g., a touch event) that occurs on the guard touch area or the display 150. According to various embodiments of the present disclosure, the object may be disposed as a fixed screen element (an element (an icon, a menu item, or the like) provided by default if a corresponding screen is displayed) of a specific screen (e.g., a home screen, a standby screen, or the like) of the display 150.

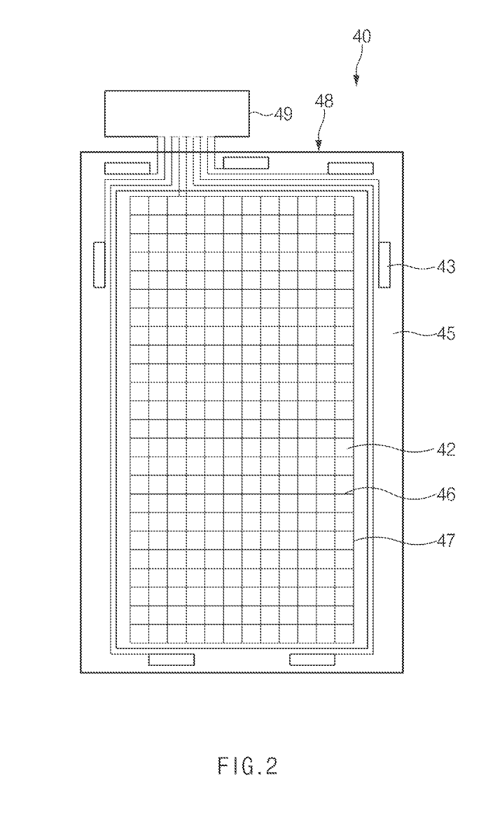

The case 300 may include a bezel surrounding an edge of one surface (e.g., at least a part of a front area) and disposed on the same surface, a side part connected to an edge of the bezel and supporting the bezel, and a rear part connected to the side part and disposed at the rear of the electronic device 100. Hardware components described in connection with various embodiments of the present disclosure may be disposed at one or more portions of the case 300 (e.g., at least one of the rear part, the side part, or the bezel including a part of the front area). In the following description, the hardware component is disposed at the bezel or the side part. However, various embodiments of the present disclosure are not limited thereto, and the hardware component may be disposed at at least a part of the rear part. At least one of the bezel, the side part, or the rear part of the case 300 may include the guard touch area (e.g., an area 45 of FIG. 2) differentiated from the area of the display 150.

The hardware component disposed at the case 300 may be a hardware component for generating or receiving a signal or for outputting a signal generated in the electronic device 100, in response to external manipulation. For example, the hardware component may include a speaker 301, an audio jack 302, an image sensor 303, at least one sensor such as a proximity sensor 304 or an infrared sensor, a fingerprint sensor, an illumination sensor, or the like, a communication antenna 305 (e.g., a digital media broadcasting (DMB) antenna, a code division multiple access (CDMA) antenna, a long term evolution (LTE) antenna, or the like), a physical key button 306, a physical key 307, a connection port 308 (e.g., a micro-universal serial bus (micro-USB) connection port), a home button 309, a physical key 310, and a physical key button 311. Additionally, the hardware component may include at least one electronic pen or touch pen disposed at the case 300. The speaker 301 may output audio data of the electronic device 100. For example, the speaker 301 may include a receiver for outputting audio data received during a voice call through the electronic device 100. According to various embodiments of the present disclosure, the speaker 301 may output audio data during an operation such as a video call or playback of music. The speaker 301 may be disposed at, for example, an upper end portion of the bezel of the case 300. According to various embodiments of the present disclosure, one or more speakers 301 may be disposed at a certain area of the rear of the case 300.

The audio jack 302 may be disposed at one side of the case 300 (e.g., the side part of the case 300). The audio jack 302 may include a hole having a certain depth so that an earphone jack may be inserted therein and a plurality of contact terminals arranged in the hole so as to be electrically connected to terminals of the earphone jack. The audio jack 302 may be disposed at, for example, an upper end of the side part of the case 300. The audio jack 302 may be disposed at an upper left end or an upper right end of the side part of the case 300, or may be disposed at a lower end of the side part of the case 300 according to a design for the electronic device 100. According to various embodiments of the present disclosure, the audio jack 302 may be connected to an external device related to an image output function. An external speaker device may also be connected to the audio jack 302. Furthermore, an external antenna device may also be connected to the audio jack 302.

The image sensor 303 may collect an image of a subject. For example, the image sensor 303 may be disposed at a front bezel area of the case 300. According to various embodiments of the present disclosure, additionally or alternatively, the image sensor 303 may be disposed at the rear part of the case 300.

The proximity sensor 304 may provide, to a processor or a function processing module of the electronic device 100, a signal based on recognition of contact of an object. The proximity sensor 304 may be disposed at, for example, an upper end area of the bezel of the case 300. According to various embodiments of the present disclosure, an infrared sensor may be disposed at the bezel area in addition to or instead of the proximity sensor 304. According to various embodiments of the present disclosure, a fingerprint sensor, a heart rate sensor, or the like may be disposed at the bezel area in addition to or instead of the proximity sensor 304.

The communication antenna 305 may transmit/receive signals in relation to operation of a communication function of the electronic device 100. The communication antenna 305 may include an antenna of various pattern types or a tunable antenna or a plurality of antennas according to the type of a communication function (e.g., a DMB communication function, a Wi-Fi communication function, a Bluetooth (BT) communication function, a mobile communication function, or the like) supported by the electronic device 100. According to an embodiment of the present disclosure, the communication antenna 305 may include a DMB antenna. At least a part of the communication antenna 305 may be disposed at the side part of the case 300, and may be manipulated so as to protrude by a certain distance (or specific range) from a surface of the side part. For example, the communication antenna 305 may be a type of a whip antenna. The communication antenna 305 may be disposed inside the case 300, having a certain pattern.

The physical key button 306 may be disposed at the side part of the case 300. The physical key button 306 may be, for example, a power button. Alternatively, the physical key button 306 may be a volume control button, a virtual quick panel control button, a virtual panel control button relate to operation of an electronic pen, or the like. Although FIG. 1 illustrates that the physical key button 306 is disposed at a right side of the side part of the case 300, the physical key button 306 may be disposed at the bezel area of the case 300 or the upper end or lower end of the side part of the case 300.

The physical key 307 may be disposed at, for example, a lower end of the bezel area of the case 300. According to an embodiment of the present disclosure, the physical key 307 may be disposed at an area where the display 150 is not disposed, for example, an area adjacent to the home button 309. In relation to the physical key 307, the electronic device 100 may include a touch panel. The touch panel related to the physical key 307 may be provided as a hardware component differentiated from the display 150. According to an embodiment of the present disclosure, the physical key 307 may provide a multi-window function or a function of a back key (e.g., a key for returning to an operation prior to a function that is currently being executed or for ending the function that is currently being executed).

The connection port 308 may be related to connection of the electronic device 100 to an external device. The connection port 308 may be disposed at the lower end of the side part of the case 300. According to various embodiments of the present disclosure, the connection port 308 may be disposed at the left side or right side of the side part of the case 300. The connection port 308 may be connected to an adaptor for charging the electronic device 100. The connection port 308 may be connected to, for example, a cable for connecting the electronic device 100 to an external device that communicates therewith. The connection port 308 may be connected to an external device that communicates with the electronic device 100 and optionally or simultaneously charges the electronic device 100. According to an embodiment of the present disclosure, the connection port 308 may be a connector including a plurality of pins (e.g., a micro-USB port or a universal asynchronous receiver/transmitter (UART) port).

The home button 309 may be disposed at the bezel area (e.g., the lower portion of the bezel area) of the case 300. The home button 309 may be associated with, for example, a command for switching to a home screen of the electronic device 100. Furthermore, the home button 309 may be associated with a command for waking up the electronic device 100 that is in a sleep state. According to various embodiments of the present disclosure, the home button 309 may be associated with a command for providing a menu related to configuration of the electronic device 100 according to a manipulation type. A command generated in response to selection of the home button 309 may be transferred to a processor of the electronic device 100 so as to be used to perform a corresponding function. According to various embodiments of the present disclosure, a fingerprint sensor may be disposed at an area of the home button 309.

The physical key 310 may be disposed at, for example, the bezel area of the case 300. For example, the physical key 310 may be disposed at an area adjacent to the home button 309. According to an embodiment of the present disclosure, the physical key 310 may be a touch key that supports a menu function. In order to support the physical key 310, the electronic device 100 may include a touch panel differentiated from the display 150.

The physical key button 311 may be disposed at, for example, the bezel area or the side part of the case 300. The physical key button 311 may be associated with, for example, a command for controlling volume of the electronic device 100. The physical key button 311 may be associated with, for example, a command related to page scrolling, switching, magnifying or reducing or execution of a specific function of the electronic device 100. The physical key button 311 may include a plurality of buttons.

Although it has been described that the physical key button 306, the physical key button 311, the physical key 307, and the physical key 310 are arranged, various embodiments of the present disclosure are not limited thereto. For example, the electronic device 100 may include one physical key button alone or one physical key alone or may include more physical key buttons or physical keys. Furthermore, the electronic device 100 may further include elements in addition to the above-mentioned hardware components, for example, various sensors, a lamp, a digitizer pen (touch pen), or the like.

FIG. 2 is a diagram illustrating a touch panel of an electronic device according to various embodiments of the present disclosure.

Referring to FIG. 2, a touch panel 40 of the electronic device may include a sensing panel 48 and a panel driving unit 49.

The sensing panel 48 may include a display touch area 42 and a guard touch area 45. The display touch area 42 may correspond to an area where the display 150 is disposed. The display touch area 42 may be at least a part (or a display area) of a front area on which a text or an image is displayed. The guard touch area 45, which is an area other than the display area, may include, for example, at least one of the non-display area of the display or a display periphery area. The display touch area 42 may support, for example, capacitive touch sensing. To this end, the display touch area 42 may include signal lines 46 and signal lines 47. For example, the signal lines 46 may serve as signal supply lines. The signal lines 47 may serve as sensing lines.

The guard touch area 45 may correspond to a part of the area of the case 300 surrounding the display 150. For example, the guard touch area 45 may be the bezel area outside the display 150. Furthermore, the guard touch area 45 may be a certain area of the rear part or the side part of the case 300. The guard touch area 45 may include at least one guard touch portion 43 for sensing a touch of an input device (e.g., a finger, an electronic pen, or the like). The guard touch portion 43 may be disposed adjacent to an area where a hardware component of the electronic device 100 is disposed. Accordingly, the guard touch portion 43 may be adjacent to at least one of a plurality of hardware component areas.

Although FIG. 2 illustrates that one guard touch portion 43 includes one signal line and a pad, various embodiments of the present disclosure are not limited thereto. For example, the guard touch portion 43 may include one common line (e.g., a signal supply line) and a plurality of signal detection lines that partially intersect with each other.

The panel driving unit 49 may sense a touch that occurs on an intersection area of the signal lines 46 and 47 arranged in the display touch area 42, and may generate a touch event corresponding to the touch. The panel driving unit 49 may provide the generated touch event to a control module (e.g., a processor, a function processing module, or the like) of the electronic device 100. In this operation, the panel driving unit 49 may collect location information on the intersection area of the signal lines 46 and 47 where the touch has occurred among intersection areas of the signal lines 46 and 47, information on a touch trajectory, or the like, and may provide the collected information.

According to various embodiments of the present disclosure, the panel driving unit 49 may sense a touch that occurs on at least one guard touch portion 43, and may generate a touch event corresponding to the touch. In this operation, the panel driving unit 49 may individually recognize the at least one guard touch portion 43.

According to various embodiments of the present disclosure, the panel driving unit 49 may operate the display touch area 42 and the guard touch area 45 individually or integrally. To this end, the panel driving unit 49 may include a panel driving module related to operation of the display touch area 42 and a panel driving module related to operation of the guard touch area 45. According to an embodiment of the present disclosure, the guard touch area 45 may be active while the display 150 is turned on. Alternatively, the guard touch area 45 may remain in an inactive state, and then may be activated when a specified function screen (e.g., a home screen or a specific application execution screen) is displayed on the display 150. According to various embodiments of the present disclosure, the guard touch area 45 may be operated independently from the display touch area 42. When a specified object is displayed on the display 150 in response to selection of the specific guard touch portion 43 of the guard touch area 45, the guard touch area 45 may be switched into an inactive state, and the display touch area 42 may be activated. Alternatively, even if the specified object is displayed on the display 150, the guard touch area 45 may remain in an active state so as to support sensing of an additional touch.

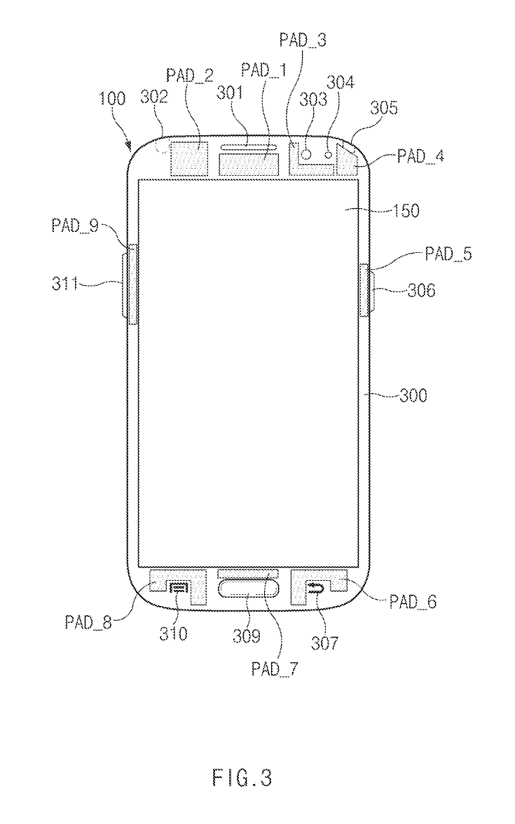

FIG. 3 is a diagram illustrating arrangement of guard touch portions according to various embodiments of the present disclosure.

Referring to FIG. 3, the electronic device 100 may include one or more guard touch portions PAD_1 to PAD_9 arranged adjacent to areas where at least one hardware component (e.g., the speaker 301, the audio jack 302, the image sensor 303, the proximity sensor 304, the communication antenna 305, the physical key button 306, the physical key 307, the home button 309, the physical key 310, and the physical key button 311). The guard touch portions may be arranged at an upper part or a lower part of a case (e.g., front cover glass, a metal cover or a plastic cover disposed at the side part or the rear part, or the like).

According to an embodiment of the present disclosure, the guard touch portions may include the guard touch portion PAD_1 adjacent to the speaker 301, the guard touch portion PAD_2 adjacent to the audio jack 302, the guard touch portion PAD_3 adjacent to the image sensor 303 and the proximity sensor 304, and the guard touch portion PAD_4 adjacent to the communication antenna 305. Furthermore, the guard touch portions may include (at least one of) the guard touch portion PAD_5 adjacent to the physical key button 306, the guard touch portion PAD_6 adjacent to the physical key 307, the guard touch portion PAD_7 adjacent to the home button 309 (or a connection port), the guard touch portion PAD_8 adjacent to the physical key 310, and the guard touch portion PAD_9 adjacent to the physical key button 311. Additionally or alternatively, the electronic device 100 may further include a guard touch portion adjacent to the connection port 308 illustrated in FIG. 1.

According to various embodiments of the present disclosure, if a specified event occurs on the guard touch portion PAD_1, the electronic device 100 may output, to the display 150, an object including function items related to a hardware component adjacent to the guard touch portion PAD_1, for example, the speaker 301, wherein the function items may include (at least one of) a speakerphone mode function item (e.g., a function of outputting output audio data to a receiver and another speaker), a whisper mode function item (e.g., a function of amplifying or increasing the volume of an input voice to transfer the input voice to another electronic device), or a driving mode function item (e.g., a function of limiting at least a part of a communication function of the electronic device 100). The specified event may include at least one of a touch event corresponding to a motion of touching the guard touch portion PAD_1, a touch event corresponding to a motion of touching the guard touch portion PAD_1 for at least a specified time (e.g., a long press motion), a touch event corresponding to a motion of touching the guard touch portion PAD_1 and then dragging in a specified direction (e.g., a direction towards the display 150), or a hovering event corresponding to a motion of hovering on the guard touch portion PAD_1.

According to various embodiments of the present disclosure, if a specified event occurs in relation to the guard touch portion PAD_2, the electronic device 100 may output, to the display 150, an object including at least one function item related to the audio jack 302. For example, the electronic device 100 may output, to the display 150, an object including (at least one of) an earphone connection function item or an AM/FM radio function item.

According to various embodiments of the present disclosure, if a specified event occurs in relation to the guard touch portion PAD_3, the electronic device 100 may output, to the display 150, an object including or associated with at least one function item related to the image sensor 303 or the proximity sensor 304. For example, in relation to the image sensor 303, the electronic device 100 may output, to the display 150, an object including (at least one of) a function item related to operation of a self camera or a function item related to iris recognition. Furthermore, the electronic device 100 may output, to the display 150, an object including (at least one of) a function item of changing an audio path (e.g., changing a receiver or audio jack output into a speaker output or vice versa) or a function item related to processing of an incoming call (e.g., rejecting a call, creating a message after rejecting a call, transmitting a specified message after rejecting a call, or the like). According to various embodiments of the present disclosure, the electronic device 100 may output, to the display 150, an object including function items related to both the image sensor 303 and the proximity sensor 304. Alternatively, the electronic device 100 may output at least one of an object related to the image sensor 303 or an object related to the proximity sensor 304 according to the type of a touch event (e.g., a tap touch event, a long press touch event, or a sweep event (corresponding to a motion of touching and then dragging in a certain direction)) that occurs on the guard touch portion PAD_3.

According to various embodiments of the present disclosure, if a specified event occurs in relation to the guard touch portion PAD_4, the electronic device 100 may output, to the display 150, an object including a function item related to the communication antenna 305. For example, the electronic device 100 may output an object including (at least one of) a function item related to viewing of DMB, a function item relate to creation of a text message, a function item related to automatic call connection (e.g., attempting to connect a call to a specific phone number), or a function item relate to establishment of a Wi-Fi communication channel. The electronic device 100 may output, to the display 150, an object including a portion of the foregoing function items according to the type of a touch event that occurs on the guard touch portion PAD_4. For example, if a tap touch event occurs, the electronic device 100 may output an object including the function item related to viewing of DMB. For another example, if a long press touch event occurs, the electronic device 100 may output an object including the function item related to automatic call connection. For another example, if a sweep event occurs, the electronic device 100 may output an object including a function item related to connection to at least one specified webpage.

According to various embodiments of the present disclosure, if a specified event occurs in relation to the guard touch portion PAD_5, the electronic device 100 may output, to the display 150, an object including a function item related to the physical key button 306. For example, in relation to a power key button, the electronic device 100 may output, to the display 150, an object including (at least one of) a function item of holding the display touch area 42 (e.g., inactivating the display touch area 42 or nullifying an event that has occurred) or a function item related to turning off power (e.g., turning off the electronic device 100), restarting, or entry into a sleep state (e.g., turning off the display 150). According to various embodiments of the present disclosure, in relation to the power key button, the electronic device 100 may output, to the display 150, an object including (at least one of) a function item of capturing a current screen or a function item of switching into an airplane mode.

According to various embodiments of the present disclosure, if a specified event occurs in relation to the guard touch portion PAD_6, the electronic device 100 may output, to the display 150, an object including a function item related to the physical key 307. For example, in relation to a back key, the electronic device 100 may output, to the display 150, an object including (at least one of) a function item related to closing a page currently displayed on the display 150, a function item of closing all pages that are currently running (e.g., running in at least one of a foreground or a background), a function item of moving to a specified page, or a function item of activating a multi-window.

According to various embodiments of the present disclosure, if a specified event occurs in relation to the guard touch portion PAD_7, the electronic device 100 may output, to the display 150, an object including a function item related to the home button 309. For example, the electronic device 100 may output an object including (at least one of) a function item of moving to a home screen or a function item of entry into a sleep state. Additionally or alternatively, the electronic device 100 may output an object including a function item of performing turning on/off or channel change of at least one specified external electronic device (e.g., a television (TV), a radio, a computer, or the like) according to a current function execution state (e.g., a state of outputting (or displaying) a lock screen, a state of outputting (or displaying) a home screen or a standby screen, or the like) of the electronic device 100. For example, the electronic device 100 may provide an object including function items for controlling operation of each of a plurality of external electronic devices. When a specific function item is selected, the electronic device 100 may output, to the display 150, a virtual remote controller corresponding to the function item. Alternatively, the electronic device 100 may provide an object only including a function item related to operation of a specified external electronic device, and may support addition of a function item related to another external electronic device or removal of a specific function item according to a setting. According to various embodiments of the present disclosure, a fingerprint sensor may be disposed at the area of the home button 309. Accordingly, if a specified event occurs in relation to the guard touch portion PAD_7, the electronic device 100 may output, to the display 150, an object including a function item related to the fingerprint sensor. For example, the electronic device 100 may output an object for outputting (or displaying) a guide related to fingerprint sensing or an object including a password setting function item based on fingerprint sensing or an application item that may be executed based on fingerprint sensing.

According to various embodiments of the present disclosure, if a specified event occurs in relation to the guard touch portion PAD_8, the electronic device 100 may output, to the display 150, an object including a function item related to the physical key 310. For example, the electronic device 100 may output an object including a function item related to a menu key (e.g., a function item related to entry into a setting of the electronic device 100, or a function item for selecting user-preferred functions of the electronic device 100). According to various embodiments of the present disclosure, if a specified event occurs in relation to the guard touch portion PAD_8, the electronic device 100 may output, to the display 150, an object including a function item related to a microphone. For example, the electronic device 100 may output an object including a recording start item, a recording volume adjusting item, or a recording mode determination item (e.g., an interview mode, a meeting mode, or the like).

According to various embodiments of the present disclosure, if a specified event occurs in relation to the guard touch portion PAD_9, the electronic device 100 may output, to the display 150, an object including a function item related to the physical key button 311. For example, the electronic device 100 may output an object including a function item related to a volume adjusting key (e.g., a call sound adjusting function item, a music playback volume adjusting function item, a recording volume adjusting function item, a function item of capturing a currently running screen, or a function item related to output of a quick panel) or a page magnifying/reducing function item.

According to various embodiments of the present disclosure, the electronic device 100 may include guard touch portions related to more various hardware components. For example, the electronic device 100 may include a guard touch portion adjacent to an area where a fingerprint sensor is disposed, a guard touch portion adjacent to an area where a heart rate sensor is disposed, a guard touch portion related to an area where an infrared sensor is disposed, or a guard touch portion related to an area where the connection port 308 is disposed. The foregoing guard touch portions may be disposed at least one of the bezel area, the side part, or the rear part of the case 300 as described above. If a specified event occurs on each guard touch portion, the electronic device 100 may output, to the display 150, an object including at least one function item related to a corresponding hardware component. For example, the electronic device 100 may output, to the display 150, an object including a function item related to the fingerprint sensor (e.g., a function item of activating the fingerprint sensor, a function item of executing an application related to fingerprint recognition, or a function item related to fingerprint recognition setting), an object including a function item related to the heart rate sensor (e.g., a function item of activating the heart rate sensor, a function item of executing an application related to the heart rate sensor, or a function item related to a user setting of the heart rate sensor), an object including a function item related to the infrared sensor (e.g., a function item of activating the infrared sensor or a remote control function item), or an object including a function item related to the connection port 308 (e.g., a function item related to a charging setting or a function item related to a communication setting).

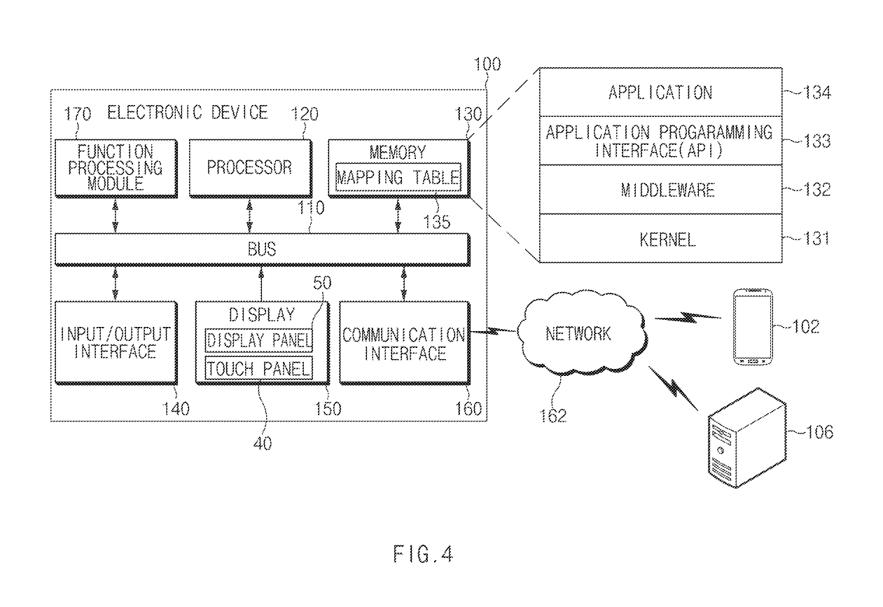

FIG. 4 is a diagram illustrating an electronic device and an operation environment thereof according to various embodiments of the present disclosure.

Referring to FIG. 4, the operation environment may include the electronic device 100, a network 162, an electronic device 102, and a server device 106.

In the above-mentioned electronic device operation environment, the network 162 may establish a communication channel between the electronic device 100 and the electronic device 102. The network 162 may include, for example, network device elements related to establishment of a mobile communication channel and network device elements related to establishment of an Internet communication channel. According to an embodiment of the present disclosure, the network 162 may establish a communication channel to the other electronic device 102 in response to selection of a function item of an object related to the guard touch area 45 (e.g., the guard touch portion adjacent to a hardware component in which the communication antenna 305 is disposed) of the electronic device 100.

The server device 106 may establish a communication channel to the electronic device 100 or the electronic device 102 via the network 162. According to an embodiment of the present disclosure, the server device 106 may establish the communication channel in response to selection of a function item of an object related to the guard touch area 45 (e.g., an area including a guard touch portion adjacent to a hardware component in which the communication antenna 305, the image sensor 303, or the home button 309 is disposed) of the electronic device 100.

The electronic device 102 may establish a communication channel to a communication interface 160 of the electronic device 100. For example, the electronic device 102 may establish a wireless communication channel (e.g., a BT communication channel or a Wi-Fi direct communication channel) or wired communication channel (e.g., a mobile high-definition link (MHL), a USB, or the like) to the communication interface 160. Referring to FIG. 4, the electronic device 100 may include a bus 110, a processor 120, a memory 130, an input/output interface 140, the display 150, the communication interface 160, and a function processing module 170.

The bus 110 may be a circuit for connecting the above-mentioned elements to each other and transferring communications (e.g., control messages, input events, data, or the like) between the above-mentioned elements. For example, the bus 110 may transfer an input signal input through the input/output interface 140 to at least one of the processor 120 or the function processing module 170. The bus 110 may transfer, to at least one of the processor 120 or the function processing module 170, a touch event that has occurred on a specific guard touch portion of the guard touch area 45. The bus 110 may transfer, for example, a mapping table 135 stored in the memory 130 to the processor 120 or the function processing module 170, and may transfer object information (e.g., information including guard touch portion information related to specific hardware component and hardware-related function items) to the display 150.

The processor 120 may receive instructions from other elements (e.g., the memory 130, the input/output interface 140, the display 150, the communication interface 160, or the function processing module 170) through the bus 110. The processor 120 may interpret the received instructions, and may perform operations or process data according to the interpreted instructions. The processor 120 may include the function processing module 170 or may be separated from the function processing module 170, and may be configured to perform communication directly or via the bus 110. The processor 120 may support processing of a function related to object operation based on the guard touch area 45 according to various embodiments of the present disclosure.

The memory 130 may store an instruction or data received from or generated by the processor 120 or another element (e.g., the input/output interface 140, the display 150, the communication interface 160, or the function processing module 170). The memory 130 may include programming modules such as a kernel 131, a middleware 132, an application programming interface (API) 133, or an application 134. Each programming module may include software, firmware, hardware, or a combination thereof.

The kernel 131 may control or manage system resources (e.g., the bus 110, the processor 120, or the memory 130) used to perform an operation or function of another programming module, for example, the middleware 132, the API 133, or the application 134. Furthermore, the kernel 131 may provide an interface for allowing the middleware 132, the API 133, or the application 134 to control or manage the system resources in relation to object operation related to a hardware component disposed at an area corresponding to the guard touch area 45 of the electronic device 100.

The middleware 132 may serve as an intermediary between the API 133 or the application 134 and the kernel 131 so that the API 133 or the application 134 communicates and exchanges data with the kernel 131. Furthermore, the middleware 132 may perform a control operation (e.g., scheduling or load balancing) with respect to operation requests received from the application 134 by using, e.g., a method of assigning a priority for using system resources (e.g., the bus 110, the processor 120, or the memory 130) of the electronic device 100 to at least one application 134.

The API 133 may be an interface for allowing the application 134 to control functions provided by the kernel 131 or the middleware 132. The API 133 may include at least one interface or function (e.g., an instruction) for, for example, file control, window control, image processing, or character control.

The application 134 may include at least one application related to operation of the electronic device 100. For example, the application 134 may include applications related to a camera function, a music playback function, a video playback function, a communication function, a recording function, a game function, or the like. According to various embodiments of the present disclosure, the application 134 may include at least one application related to a hardware component disposed at an area corresponding to the guard touch area 45. For example, the application 134 may include an image sharing application, an image search and display application (e.g., a gallery function), or an image collection application related to an image sensor. According to various embodiments of the present disclosure, the application 134 may include an object operating application related to object operation based on the guard touch area 45.

The object operating application may be a program configured to output a specified object (e.g., an object including or associated with at least one function item) in response to occurrence of an event based on a guard touch portion related to the guard touch area 45 among adjacent areas to a specific hardware component. The object operating application may provide a function related to adjustment (e.g., removal, addition, or location change) of a function item included in an object. The object operating application may provide a function of requesting activation of a function associated with an object or an application corresponding to a function item when the object is selected or the function item included in the object is selected.

Additionally or alternatively, the memory 130 may include the mapping table 135. The mapping table 135 may include information on mapping between a specific guard touch portion of the guard touch area 45 (or a guard touch portion related to an area where a hardware component is disposed) and a specific object. For example, the mapping table 135 may store object information including guard touch portion information for the guard touch area 45 related to the audio jack 302 and an object corresponding to function items related to the audio jack 302. For example, the mapping table 135 may store object information including guard touch portion information for the guard touch area 45 in which a back key is disposed and an object corresponding to function items related to the back key. Furthermore, the mapping table 135 may store object information including guard touch portion information related to another hardware component disposed in the guard touch area 45 and an object corresponding to function items related to the hardware component.

The input/output interface 140 may transfer an instruction or data input by a user through an input/output device (e.g., a sensor, a keyboard, or a touch screen) to the processor 120, the memory 130, the communication interface 160, or the function processing module 170 through the bus 110. According to various embodiments of the present disclosure, the input/output interface 140 may include a physical key, a physical key button, and the touch panel 40 disposed at the display touch area 42. The input/output interface 140 may transfer an event that has occurred on a specific input device (e.g., a physical key, a physical key button, or a touch panel) to at least one of the processor 120 or the function processing module 170.

According various embodiments of the present disclosure, the input/output interface 140 may perform a function related to audio processing. To this end, the input/output interface 140 may include one or more speakers 301 and/or one or more microphones. For example, the input/output interface 140 may output, through the speaker, audio data related to a screen output to the display 150 according to control by the function processing module 170. According to an embodiment of the present disclosure, the input/output interface 140 may include the audio jack 302. As described above, the audio jack 302 may be connected to an earphone, a headset, a TV out cable, or the like. Furthermore, the input/output interface 140 may include the connection port 308.

The display 150 may display various information (e.g., multimedia data, text data, or the like). For example, the display 150 may output a lock screen, a standby screen, or the like. The display 150 may output a specific function execution screen such as a sound source playback screen, a video playback screen, a broadcast receiving screen, or the like according to execution of a function. The display 150 may include a display panel 50 for outputting a screen and the touch panel 40 that supports a touch function.

According to an embodiment of the present disclosure, the display 150 may output an object including at least one specified function item in response to an event that occurs on a specific guard touch portion of the guard touch area 45. The display 150 may display movement of an object in response to an input event. The display 150 may output a function execution screen in response to selection of a specific function item of an object. The display 150 may output an object editing screen.

The communication interface 160 may establish a communication connection between the electronic device 100 and an external electronic device (e.g., at least one of the electronic device 102 or the server device 106). For example, the communication interface 160 may be connected to the network 162 based on a wireless or wired communication technology so as to communicate with the external device. The wireless communication technology may include at least one of Wi-Fi, BT, near field communication (NFC), global positioning system (GPS), or cellular communications (e.g., LTE, LTE-advanced (LTE-A), CDMA, wireless CDMA (WCDMA), universal mobile telecommunications system (UMTS), wireless broadband (WiBro), or global system for mobile communications (GSM). The wired communications may include at least one of USB, high definition multimedia interface (HDMI), MHL, recommended standard 232 (RS-232), or plain old telephone service (POTS).

The communication interface 160 may include the communication antenna 305. The communication interface 160 may include at least one communication antenna 305 according to a communication method supported by the communication interface 160. For example, in the case where the communication interface 160 supports a function of receiving a broadcast, the communication antenna 305 may include a broadcast receiving antenna. Furthermore, in the case where the communication interface 160 supports a function related to mobile communication, the communication antenna 305 may include a mobile communication antenna.

The function processing module 170 may output an object according to an event that occurs on the guard touch area 45. When an object is selected or a specific function item included therein is selected, the function processing module 170 may handle execution of a function corresponding to the function item. The function processing module 170 may handle editing of function items of an object, changing of a location of an object, object integration, separation or removal of function items of an object, or the like. The function processing module 170 may be included in the processor 120 or may be provided as a separate module.

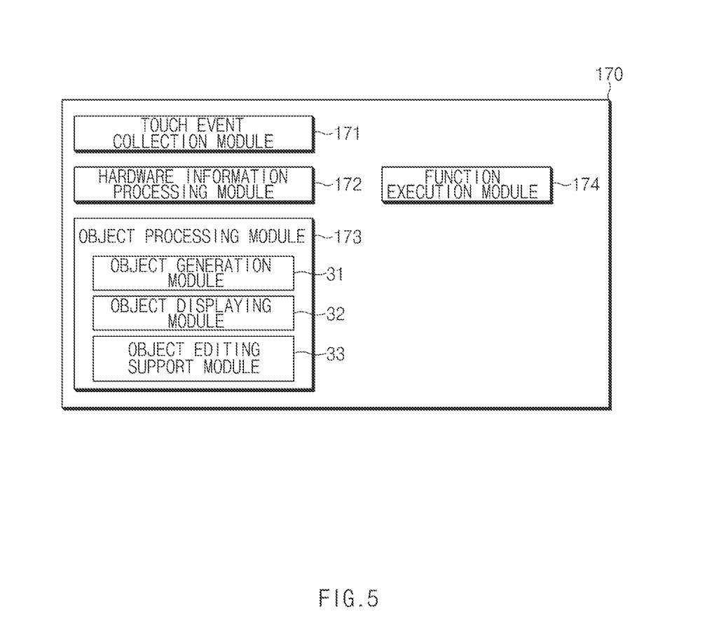

FIG. 5 is a diagram illustrating a function processing module according to various embodiments of the present disclosure.

Referring to FIG. 5, the function processing module 170 may include a touch event collection module 171, a hardware information processing module 172, an object processing module 173, and a function execution module 174.

According to various embodiments of the present disclosure, the touch event collection module 171 may collect a touch event (or a hovering event) of the electronic device 100. To this end, the touch event collection module 171 may control activation of at least one of the guard touch area 45 or the display touch area 42. For example, if the display 150 is in a turned-on state, the touch event collection module 171 may activate at least one of the guard touch area 45 or the display touch area 42. According to various embodiments of the present disclosure, if a lock screen is being output, the touch event collection module 171 may activate the display touch area 42. If the lock screen is released, the touch event collection module 171 may activate at least one of the guard touch area 45 or the display touch area 42.

According to various embodiments of the present disclosure, the touch event collection module 171 may transfer, to the hardware information processing module 172, information on an event that has occurred on a specific guard touch portion of the guard touch area 45. For example, the touch event collection module 171 may transfer, to the hardware information processing module 172, information on a guard touch portion of the guard touch area 45 on which an event has occurred. According to various embodiments of the present disclosure, the touch event collection module 171 may transfer, to the hardware information processing module 172, information on the type of an event (e.g., an event of touching and then dragging in a specific direction) that has occurred on a guard touch portion.

According to various embodiments of the present disclosure, the touch event collection module 171 may collect an event related to an object while the object including a specific function item is displayed on the display touch area 42. For example, the touch event collection module 171 may collect an event of selecting at least one function item (e.g., a touch event) included in an object, and may transfer the event to the function execution module 174. According to various embodiments of the present disclosure, the touch event collection module 171 may collect an event related to moving, position-adjusting, or fixing an object, an event related to changing a shape or size of an object, or the like. The touch event collection module 171 may transfer, to the object processing module 173, an event collected in relation to an object location. The touch event collection module 171 may transfer, to the object processing module 173, an event that occurs in a state in which an object editing screen is displayed.

According to various embodiments of the present disclosure, the hardware information processing module 172 may receive event information related to a guard touch portion from the touch event collection module 171. The hardware information processing module 172 may obtain hardware information (e.g., a hardware component type) corresponding to the event information related to the guard touch portion based on the mapping table 135. The hardware information processing module 172 may transfer the obtained hardware information to the object processing module 173.

According to various embodiments of the present disclosure, the hardware information processing module 172 may collect hardware state information. For example, the hardware information processing module 172 may collect information on a hardware component adjacent to a guard touch portion. The hardware information processing module 172 may check an operation state of the hardware. For example, in the case where the hardware component is the audio jack 302, the hardware information processing module 172 may collect hardware state information about a state of insertion or ejection of an external device, a state of data output through an external device, or a state of device control according to a button input. The hardware information processing module 172 may transfer the hardware state information to the object processing module 173.

According to various embodiments of the present disclosure, the object processing module 173 may receive, from the touch event collection module 171, a touch event that has occurred on the guard touch area 45 or the display touch area 42. Furthermore, the object processing module 173 may receive hardware information or hardware state information from the hardware information processing module 172. The object processing module 173 may support at least one of generation, displaying, or editing of an object based on the received touch event and hardware information or hardware state information. In relation to this operation, the object processing module 173 may include an object generation module 31, an object displaying module 32, and an object editing support module 33.

According to various embodiments of the present disclosure, the object generation module 31 may generate an object or may obtain specified object information based on at least one of the hardware information or the hardware state information and the mapping table 135. For example, the object generation module 31 may obtain at least one function item information configured in relation to specific hardware information or hardware state information based on the mapping table 135. The object generation module 31 may generate an object to be output to the display 150, based on the obtained function item information.

According to various embodiments of the present disclosure, the object generation module 31 may generate objects including different types of function items according to the hardware information. Furthermore, the object generation module 31 may generate objects including different types of function items according to the hardware state information. If a hardware state is changed, the object generation module 31 may generate an object including function items corresponding to a changed hardware state. The object generation module 31 may provide a generated object or specified object information to the object displaying module 32.

According to various embodiments of the present disclosure, the object displaying module 32 may output, to the display 150, an object generated by the object generation module 31 or a specified object (e.g., an object pre-stored in the memory 130) obtained by the object generation module 31. In this operation, the object displaying module 32 may display at least one function item. Furthermore, the object displaying module 32 may display an object including at least one of a certain image or text in relation to a specific hardware component (e.g., a hardware component adjacent to a guard touch portion on which an event has occurred). If an event of requesting displaying of a function item included in an object (e.g., an event of selecting an object displayed on the display 150) occurs, the object displaying module 32 may display the function item included in the object. According to various embodiments of the present disclosure, the object displaying module 32 may remove at least one function item in response to occurrence of a specific event, may maintain remaining function items, and may control displaying of an object from which a function item has removed.

The object displaying module 32 may display an object on a specified location. For example, the object displaying module 32 may display an object in relation to a location of a touch event (e.g., a location adjacent to a portion on which a touch event has occurred) that has occurred on the guard touch area 45. The object displaying module 32 may adjust a position of an object on the display 150 in response to occurrence of an event related to object movement (e.g., an event of selecting and then dragging an object). According to various embodiments of the present disclosure, the object displaying module 32 may fix a position of a specific object. For example, the object displaying module 32 may fix, according to a setting, an object to a certain portion on a home screen, a certain portion on a standby screen, or a certain portion on a lock screen. The fixed object may be output while a corresponding screen is displayed on the display 150. According to various embodiments of the present disclosure, the object displaying module 32 may treat the fixed object as a temporary object (e.g., an object that is removed when a corresponding screen is closed, but is not displayed again when the closed screen is output again) in response to an input event.

According to various embodiments of the present disclosure, the object displaying module 32 may perform an operation related to object removal. For example, the object displaying module 32 may remove an object if a certain time elapses after the object is displayed. Alternatively, the object displaying module 32 may remove an object from the display 150 if an input event related to the object does not occur within a specified time. Alternatively, if an input event related to object removal (e.g., an event of selecting a virtual cancellation button disposed adjacent to an object) occurs, the object displaying module 32 may remove an object from the display 150. Alternatively, if a specified function is performed in response to selection of a function item, the object displaying module 32 may remove a corresponding object from the display 150.

According to various embodiments of the present disclosure, the object displaying module 32 may display a plurality of objects. For example, if an event related to a plurality of guard touch portions (e.g., an event of sequentially or simultaneously touching a plurality of guard touch portions) occurs on the guard touch area 45, the object displaying module 32 may output, to the display 150, objects related to a hardware component corresponding to the guard touch portions. In this operation, the object displaying module 32 may arrange each object on an area of the display 150 adjacent to the guard touch portions.

According to various embodiments of the present disclosure, the object editing support module 33 may support object editing in response to reception of an event related to object editing. For example, the object editing support module 33 may provide at least one icon or menu item related to entry into an object editing mode. If an event of selecting an icon or a menu related to the object editing mode is received, the object editing support module 33 may output an object editing screen to the display 150.

The object editing screen may have a text or a screen state (e.g., layer differentiation between a background screen and an editing screen) indicating object editing. If a touch event occurs on the guard touch area 45 related to a specific hardware component while the object editing screen is output, the object editing support module 33 may output function items related to the hardware component. If a connection request related to a hardware component (e.g., an event of selecting a function item and then dragging it to the guard touch area 45 where a hardware component is disposed) is made, the object editing support module 33 may add a function item of an object related to the hardware component to an object associated with the hardware component. In this operation, the object editing support module 33 may update the mapping table 135.

According to various embodiments of the present disclosure, the object editing support module 33 may display at least one function item included in a specific object. If an event related to removal of a specific function item (e.g., an event of selecting a specific function item included in an object and dragging it in a certain direction) occurs, the object editing support module 33 may remove the specific function item from a corresponding object. Furthermore, the object editing support module 33 may integrate or divide a plurality of objects. For example, a plurality of hardware components may be arranged at one guard touch portion. In this case, when a specific guard touch portion is selected (or when a plurality of guard touch portions related to a plurality of hardware components are selected), the object displaying module 32 may output a plurality of objects related to respective hardware components to the display 150. The object editing support module 33 may additionally handle removal or addition of an object related to a specific hardware component at a guard touch portion to which a plurality of hardware components are mapped, in response to a setting change or a user input.

According to various embodiments of the present disclosure, if a specific function item included in an object is selected, the function execution module 174 may handle performance of a function corresponding to the function item. For example, while a specific object is output to the display 150 in response to selection of a guard touch portion related to an image sensor, if a function item included in the object and presented as a camera activation icon is selected, the function execution module 174 may perform control so that the image sensor is activated. Furthermore, the function execution module 174 may output, to the display 150, a preview image collected by the activated image sensor.

According to various embodiments of the present disclosure, if a specific function item is selected from among function items differently output according to a hardware state, the function execution module 174 may handle performance of a corresponding function. If a hardware state is changed, the function execution module 174 may perform control so that a function that is currently being executed is terminated and a specified function is automatically performed according to the changed state. For example, if a specified event occurs on a guard touch portion related to the audio jack 302 while an earphone is connected to the audio jack 302, the object displaying module 32 may display an object including a function item related to music playback based on support of the object generation module 31. If the function item related to music playback is selected, the function execution module 174 may activate a music player so that a specified music file may be played or a music file list may be output. In this state, if the earphone is separated from the audio jack 302, the function execution module 174 may perform control so that music playback is temporarily suspended. Alternatively, if the earphone is separated from the audio jack 302, the function execution module 174 may perform control so that audio data is output through the speaker 301. As described above, the function execution module 174 may handle, according to an input event, various function items provided differently according to the hardware information or the hardware state information.

According to various embodiments of the present disclosure, the function execution module 174 may provide information indicating whether a selected function is executable according to the type or state of a currently displayed screen or running application. For example, if a specific function item is selected while a lock screen is not released, the function execution module 174 may notify that a function related to the function item is executed after the lock screen is released. If the lock screen is released, the function execution module 174 may automatically perform the function related to the selected function item.

As described above, according to various embodiments of the present disclosure, a mobile electronic device according to an embodiment of the present disclosure may include a display, a guard touch area corresponding to at least one hardware component disposed outside the display, and a function processing module configured to output an object associated with the hardware component to the display according to an input to the guard touch area.

As described above, according to various embodiments of the present disclosure, an electronic device according to an embodiment of the present disclosure may include a display configured to output at least one object, at least one hardware component disposed in an area other than an area of the display, a guard touch area disposed within a certain distance (or specific range) from the at least one hardware component, and a function processing module configured to output an object associated with the hardware component to the display according to an input event occurring on the guard touch area.

According to various embodiments of the present disclosure, the hardware component may include at least one of an audio jack, at least one sensor, at least one physical key or physical key button, a speaker, an antenna, a connection port, or an electronic pen.

According to various embodiments of the present disclosure, the guard touch area may be extended (e.g., connected in series or disposed in parallel within a certain area (e.g., a common area)) to a touch pattern arranged in the display.

According to various embodiments of the present disclosure, the guard touch area may include an area of at least one of a bezel surrounding an edge of the display, a side part connected to the bezel, or a rear part connected to the side part.

According to various embodiments of the present disclosure, the function processing module may output an object that supports input of an event for requesting execution of at least one function related to the hardware component or may output an object including a function item or an item for requesting execution of the at least one function related to the hardware component.

According to various embodiments of the present disclosure, the function processing module may differently output at least one of the shape of the object or the type of a function item included in the object according to hardware state information related to device operation of the hardware component.

According to various embodiments of the present disclosure, the function processing module may collect, as the hardware state information, at least one of information indicating whether an external device is connected to the audio jack, information indicating whether an external device is connected to the connection port, information indicating whether the sensor is active or inactive, information indicating whether the antenna is operated, information indicating whether the speaker outputs audio data, or information indicating whether the electronic pen is operated.

According to various embodiments of the present disclosure, the function processing module may provide a menu or a screen related to editing of the shape of the object or at least one function item included in the object according to the input event.

According to various embodiments of the present disclosure, the function processing module may remove the at least one function item from the object or may add a new function item thereto according to the input event.

According to various embodiments of the present disclosure, the function processing module may output the object to a display area adjacent to a hardware component related to a corresponding function, and may adjust a position of the object or may fix the object to a certain portion of a displayed screen or the display according to the input event.

According to various embodiments of the present disclosure, an electronic device according to an embodiment of the present disclosure may include a memory for storing at least one object related to manipulation or operation of a hardware component and a processor connected to the memory, wherein, if an input event that specifies or indicates the hardware component is received, the processor may output an object associated with the operation of the hardware component to a display area having a touch function.

According to various embodiments of the present disclosure, the processor may output the object when a touch event occurs on an area adjacent to the hardware component or a voice input event that indicates the hardware component occurs. The processor may display the object on a display area substantially adjacent to a portion where the hardware component is disposed.

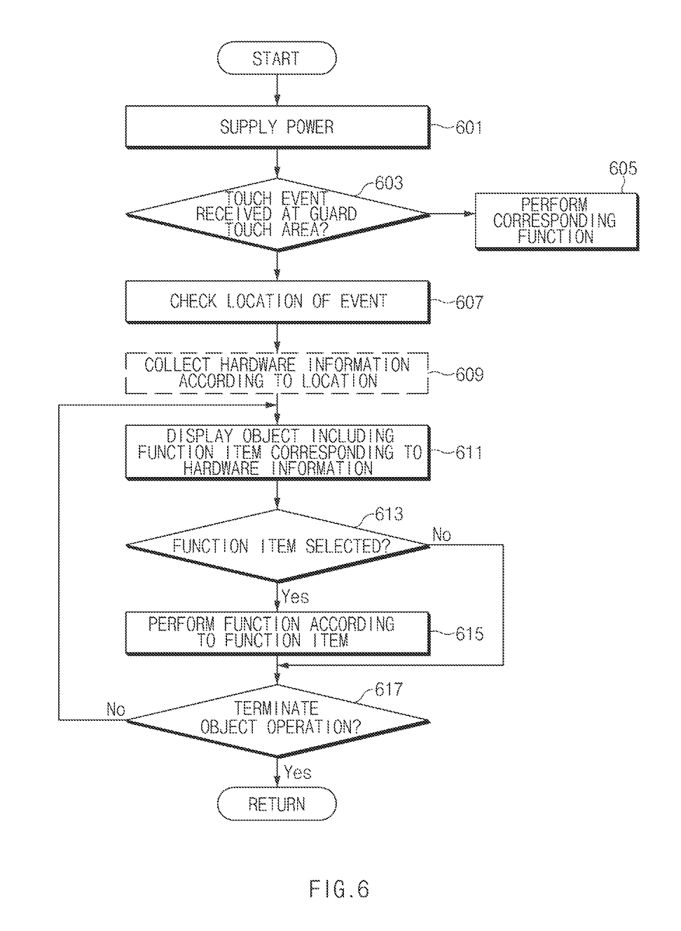

FIG. 6 illustrates an electronic device operating method related to hardware-based touch area operation according to various embodiments of the present disclosure.

Referring to FIG. 6, in operation 601, if the electronic device 100 is supplied with power, the function processing module 170 may control supply of power to at least one element of the electronic device 100. For example, the function processing module 170 may provide, to each element of the electronic device 100 (e.g., the processor 120, the communication interface 160, the input/output interface 140, or the like), power supplied from a battery or a charging device. According to an embodiment of the present disclosure, the function processing module 170 may control supply of power to the display 150 so as to activate at least one of the guard touch area 45 or the display touch area 42. For example, the function processing module 170 may control supply of power to the guard touch area 45 so that a touch or hovering event is allowed to be input by a specific object (e.g., a part of a human body or an input tool). In operation 603, if a specific event occurs, the function processing module 170 may determine whether the event has occurred on the guard touch area 45. The guard touch area 45 may be a touch-enabled area outside the display 150. For example, the guard touch area 45 may include at last one of the bezel area of the case 300 surrounding the display 150, the side part connected to the bezel, or the rear part connected to the side part. The guard touch area 45 may include at least one guard touch portion disposed adjacent to a hardware component included in the electronic device 100.

If the event that has occurred is not related to the guard touch area 45, the function processing module 170 may handle execution of a corresponding function according to the type or characteristic of the event in operation 605. For example, home button input or power key button input occurs, the function processing module 170 may turn on the display 150 or may output a home screen to the display 150. If the event has occurred on an area of the display 150, the function processing module 170 may switch screens or may perform a specific function according to a position or type of the event.

If the event that has occurred is related to the guard touch area 45, the function processing module 170 may check a location of the event in operation 607. For example, the function processing module 170 may determine on what guard touch portion of the guard touch area 45 the event has occurred. In relation to this operation, the guard touch area 45 may be arranged so that guard touch portions are differentiated from each other. For example, the guard touch area 45 may include a plurality of guard touch portions defined by one signal supply line and a plurality of sensing lines. Alternatively, the guard touch area 45 may include a plurality of guard touch portions defined by a plurality of signal supply lines and a plurality of sensing lines.

In operation 609, the function processing module 170 may collect hardware information according to an event occurrence location. The function processing module 170 may check the hardware information mapped to the guard touch portion based on the mapping table 135 stored in the memory 130. According to various embodiments of the present disclosure, the function processing module 170 may skip operation 609. For example, if a function location is determined, the function processing module 170 may output an object including a function item corresponding to the hardware information mapped to the determined location in operation 611, without performing operation 609.

In operation 611, the function processing module 170 may display, on the display 150, the object including the function item corresponding to the hardware information. In relation to this operation, the function processing module 170 may collect information on function items configured to be included in the object among a plurality of function items corresponding to the hardware information. The object may include image or text information related to the function items, or may present or hide the function items according to an input event. In relation to an operation of displaying the object including or associated with the function items, the function processing module 170 may check the number of the function items, and may adjust at least one of a display position, a display type, or a display size of the object according to the number. The function processing module 170 may display the object on a layer different from that of a currently displayed screen. Alternatively, the function processing module 170 may display the object as an element of the currently displayed screen. If an event related to adjustment of an object position occurs, the function processing module 170 may adjust the position of the object according to the event. According to various embodiments of the present disclosure, if a touch event occurs on a guard touch portion to which an object in which function items related to a plurality of hardware components are integrated is mapped, the function processing module 170 may display one object in which function items of respective hardware components are integrated.

According to various embodiments of the present disclosure, while an object related to a specific hardware component is displayed, if a touch event related to other hardware components occurs on the guard touch area 45, the function processing module 170 may display an object corresponding to each hardware component on a specific location (e.g., a location adjacent to the guard touch area 45 where each hardware component is disposed). If an event of selecting a function item included in an object and then moving it to another object occurs, the function processing module 170 may adjust arrangement of function items of the objects (e.g., addition or copy of a function item of a specific object or removal of a function item of another object). If the number of function items is changed, the function processing module 170 may adjust at least one of a shape, a size, or a position of an object.

The function processing module 170 may determine whether an event related to selection of a function item occurs in operation 613. If an event related to selection of a specific function item occurs, the function processing module 170 may handle execution of a function according to the function item in operation 615. For example, if a function item related to activation of an image sensor is selected, the function processing module 170 may activate the image sensor, and may output an obtained preview image to the display 150. For another example, if a function item related to server device access is selected, the function processing module 170 may handle server device access and server page output based on the communication antenna 305 and the communication interface 160. For another example, if a function item related to a back key (or a back space key) is selected or an object including the function item is selected, the function processing module 170 may switch a current screen to a previous screen or may terminate a function being executed.

The function processing module 170 may determine whether an event related to termination of object operation occurs in operation 617. For example, the function processing module 170 may determine whether an event corresponding to a specified situation occurs, wherein the specified situation includes the case where a specified period of time expires without occurrence of selection of a function item, the case where an input event for instructing that an object should be terminated is received, the case where a function that is being executed is terminated, and the case where a function item selection event has occurred. If the event related to termination of object operation does not occur, the process may return to operation 611 so that the function processing module 170 may re-perform operation 611 and the following operations. Alternatively, the process may return to operation 603 so that the function processing module 170 may handle displaying and operation of an additional object in response to reception of an event that additionally occurs on the guard touch area 45. If the event related to termination of object operation occurs, the function processing module 170 may remove an object displayed on the display 150. Additionally or alternatively, the function processing module 170 may inactivate the guard touch area 45. The function processing module 170 may make a current screen return to a previous screen displayed prior to object generation or a previous screen displayed prior to execution of a selected function item. Alternatively, the function processing module 170 may output a specified screen (e.g., a home screen or a standby screen). Alternatively, the function processing module 170 may only remove the object from a screen.

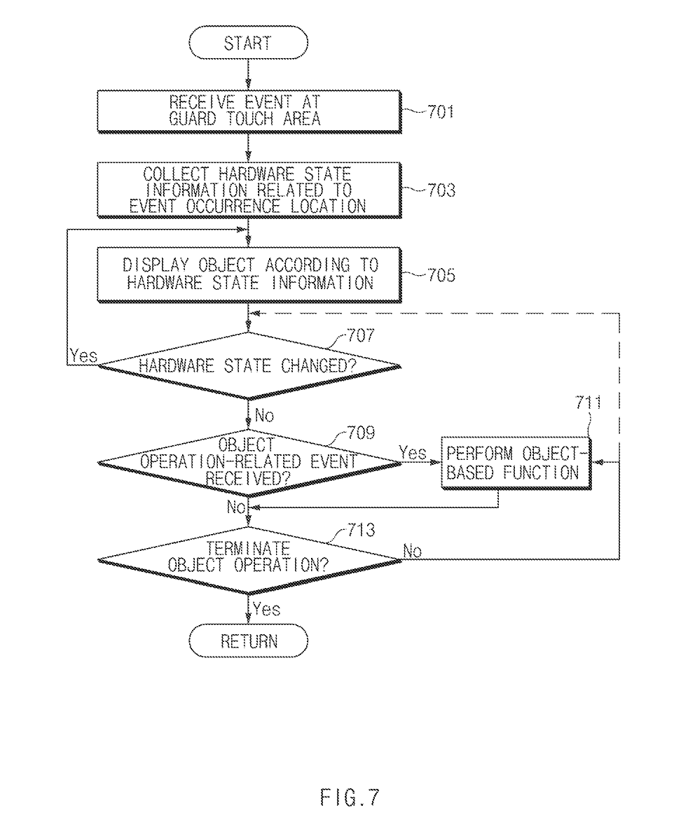

FIG. 7 illustrates an electronic device operating method related to object operation based on hardware state information according to various embodiments of the present disclosure.

Referring to FIG. 7, in operation 701, the function processing module 170 may receive an event from the guard touch area 45. Alternatively, if a specific event occurs, the function processing module 170 may determine whether the event has occurred on the guard touch area 45.

If the event has occurred on a specific guard touch portion of the guard touch area 45, the function processing module 170 may collect hardware state information related to an occurrence location of the event in operation 703. According to an embodiment of the present disclosure, the hardware state information may include information on an operation state of a hardware component. For example, regarding the audio jack 302, the hardware state information may include information indicating whether an earphone device is connected, information indicating whether a TV output device (e.g., a cable or an external device including a cable) is connected, or information indicating whether an external antenna is connected. According to various embodiments of the present disclosure, regarding the connection port 308, the hardware state information may include information indicating whether a charging device is connected to the connection port 308, information indicating whether a communication device is connected to the connection port 308, or information indicating whether a device that selectively performs communication or charging is connected to the connection port 308. Furthermore, the hardware state information may include a characteristic of an external electronic device connected to the connection port 308 or a speed of communication with the external electronic device. According to various embodiments of the present disclosure, regarding an application that is currently running, the hardware state information may include type information on one or more applications that are currently running, type information on an application corresponding to a screen disposed on an uppermost layer of the display 150, or information on a running state of an application that has been run at least a specified number of times within a certain period of time.

In operation 705, the function processing module 170 may control displaying of an object according to the hardware state information. In relation to this operation, the mapping table 135 may include function item information provided for each hardware component state information. The function processing module 170 may check the mapping table 135 so as to collect function item information mapped to a current hardware state. According to various embodiments of the present disclosure, the function processing module 170 may collect object information provided as different images for each hardware state, and may display an object corresponding to the object information. For example, in the case where an earphone device is connected to the audio jack 302, the function processing module 170 may display an object including a music playback function item, a call function item, a video playback function item, or the like. In the case where an earphone device is not connected to the audio jack 302, the function processing module 170 may display an object including a function item of adjusting the volume of audio data to be output to an external electronic device, a function item of setting a phone number of another electronic device to which a call is to be automatically made when the earphone device is connected, a function item of setting subtitle display for playback of a video, or the like. According to various embodiments of the present disclosure, the function processing module 170 may display an object of which at least one of a display size, a display position, or a display type (e.g., a color, a shape, a pattern, or the like) is changed according to whether or not an external device is connected to the audio jack 302.

In operation 707, the function processing module 170 may determine whether a hardware state is changed. If the hardware state is changed, the process may return to operation 705 so that the function processing module 170 may control displaying of an object according to the changed hardware state. For example, if the hardware state is changed before the object is displayed, the function processing module 170 may change a setting. For example, if the hardware state is changed while the object is displayed, the function processing module 170 may change at least one function item of the object being output. For example, if an external device connected to a hardware component is disconnected therefrom, the function processing module 170 may output an object of which function items for a connected state have been replaced with function items for a disconnected state. According to various embodiments of the present disclosure, if an external device is disconnected, the function processing module 170 may remove a relevant object from the display 150.

If there is no hardware state change, the function processing module 170 may determine whether an event related to object operation is received in operation 709. For example, the function processing module 170 may determine whether a touch event of selecting a specific function item included in an object occurs. If an event related to selection of a specific function item occurs, the function processing module 170 may control object-based function execution in operation 711. For example, the function processing module 170 may control execution of a function corresponding to the specific function item included in the object.

If the event related to selection of the specific function item does not occur, the function processing module 170 may determine whether an event related to termination of object operation occurs in operation 713. If the event related to termination of object operation does not occur, the function processing module 170 may continue to control the object-based function execution in operation 711. Additionally or alternatively, if the event related to termination of object operation does not occur, the process may return to operation 707 so that the function processing module 170 may re-perform operation 707 and the following operations.

If the event related to termination of object operation occurs, the function processing module 170 may make a current screen return to a specified screen (e.g., a home screen, a standby screen, or a screen displayed prior to object operation). In this operation, the function processing module 170 may remove a displayed object from the display 150. Furthermore, the function processing module 170 may terminate a function that is currently being executed, and may remove a corresponding screen from the display 150.

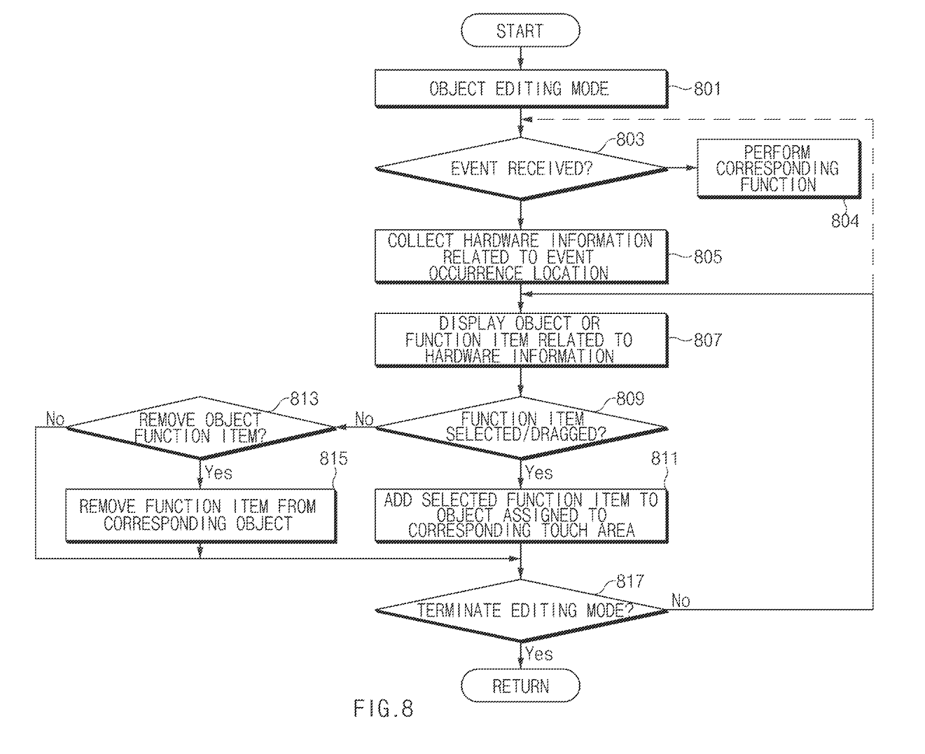

FIG. 8 illustrates an electronic device operating method related to editing of an object according to various embodiments of the present disclosure.

Referring to FIG. 8, in operation 801, the function processing module 170 may receive an event related to an object editing mode. In relation to this operation, the function processing module 170 may provide, for example, an icon or a menu related to the object editing mode. If the icon or the menu is selected, the function processing module 170 may output, to the display 150, a screen related to the object editing mode (e.g., an object editing screen).

In operation 803, for example, the function processing module 170 may determine whether a specific event (e.g., a touch event corresponding to a touch on a specific portion) is received from the guard touch area 45. If an event not related to the guard touch area 45, such as an event related to the display touch area 42, occurs, the function processing module 170 may handle execution of a corresponding function according to the type or attribute of the event in operation 804. For example, according to the type of the event, the function processing module 170 may control turning-on of the display 150, activation of a specific communication function, activation of a music playback function, or the like.

If an event related to the guard touch area 45 (e.g., an event of touching a guard touch portion adjacent to a specific hardware component), the function processing module 170 may collect hardware information related to an occurrence location of the event in operation 805. In this operation, the function processing module 170 may refer to the mapping table 135 stored in the memory 130. The mapping table 135 may include information on function items configured in relation to hardware information or information on an object including at least one function item. The function processing module 170 may also collect at least one function item information to be provided according to hardware state information or object information including information on function items.

If the function item information or the object information is collected, the function processing module 170 may display a function item related to the hardware information or may display an object in operation 807. In this operation, the function processing module 170 may output the object (or at least one function item) to an area of the display 150 adjacent to an area where a hardware component is disposed. Alternatively, the function processing module 170 may output the object (or the function item) to a specified portion of the display 150. In the object editing mode, an object displayed on the display may include all function items that are configurable in relation to a specific hardware component. According to various embodiments of the present disclosure, the function processing module 170 may also output, to the display, an object associated with the guard touch area 45 related to a specific hardware component and an object including all function items related to the specific hardware component.

In operation 809, the function processing module 170 may determine whether an event that has occurred is a specified event (e.g., an event of selecting and dragging a function item). According to an embodiment of the present disclosure, the function processing module 170 may determine whether the event is an event of selecting a specific function item displayed on the display 150 and then dragging it in a specific direction (e.g., in a direction towards the guard touch area 45 where a specific hardware component is disposed). If the event of selecting and dragging a function item occurs, the function processing module 170 may add the selected function item to an object assigned to the corresponding guard touch area 45 in operation 811.

If the event that has occurred is not the specified event, the function processing module 170 may determine whether the event is related to removal of an object function item in operation 813. If an event related to removal of an object function item (e.g., a touch event of touching the guard touch area 45 related to a specific hardware component in the object editing mode) occurs, the function processing module 170 may output a set object to the display 150. Furthermore, if a specific event (e.g., an event of selecting at least one of function items included in the set object and then dragging it in a certain direction or an event of touching a specific function item at least a certain number of times) occurs, the function processing module 170 may remove a function item selected by the specific event from the object.

If the event that has occurred is not related to removal of an object, the function processing module 170 may determine whether the event is related to termination of the editing mode in operation 817. If an event related to termination of the editing mode occurs, the function processing module 170 may terminate the object editing mode (e.g., remove the object editing screen from the display 150), and may output, to the display 150, a specified screen (e.g., a screen displayed prior to the object editing screen, a home screen, a standby screen, or a user-defined screen). If the event that has occurred is not related to termination of the editing mode, the process may return to operation 807 so that the function processing module 170 may re-perform operation 807 and the following operations. In addition, the process may proceed to operation 817 after operation 811 or 815 is performed so that the function processing module 170 may re-perform operation 817 and the following operations.

As described above, according to various embodiments of the present disclosure, an input supporting method according to an embodiment of the present disclosure may include receiving an input event at a guard touch area disposed within a certain distance (or specific range) from at least one hardware component disposed in an area other than an area of a display, and outputting an object associated with the hardware component to the display according to the input event.

According to various embodiments of the present disclosure, the receiving of the input event may include receiving an event from the guard touch area where at least one of an audio jack, at least one sensor, at least one physical key or physical key button, a speaker, an antenna, a connection port, or an electronic pen is disposed.

According to various embodiments of the present disclosure, the receiving of the input event may include receiving the input event from the guard touch area disposed in at least one of a bezel, a side part connected to the bezel, or a rear part connected to the side part, the bezel being extended in series to a touch pattern disposed in the display or being disposed in parallel within a certain area, the bezel surrounding an edge of the display.

According to various embodiments of the present disclosure, the outputting may include at least one of outputting an object that supports input of an event for requesting execution of at least one function related to the hardware component and outputting an object including a function item or an item for requesting execution of the at least one function related to the hardware component.

According to various embodiments of the present disclosure, the outputting may include collecting hardware state information related to device operation of the hardware component and differently outputting at least one of a shape of the object or a type of a function item included in the object according to the hardware state information.

According to various embodiments of the present disclosure, the collecting may include collecting at least one of information indicating whether an external device is connected to the audio jack, information indicating whether an external device is connected to the connection port, information indicating whether the sensor is active or inactive, information indicating whether the antenna is operated, information indicating whether the speaker outputs audio data, or information indicating whether the electronic pen is operated.

According to various embodiments of the present disclosure, the method may further include outputting a menu or a screen related to editing of the shape of the object or at least one function item included in the object according to the input event.

According to various embodiments of the present disclosure, the method may further include removing the at least one function item from the object or adding a new function item thereto according to the input event.

According to various embodiments of the present disclosure, the method may further include adjusting a position of the object or fixing the object to a certain portion of a displayed screen or the display according to the input event.

According to various embodiments of the present disclosure, the outputting may include outputting the object to a display area adjacent to a hardware component related to a corresponding function.

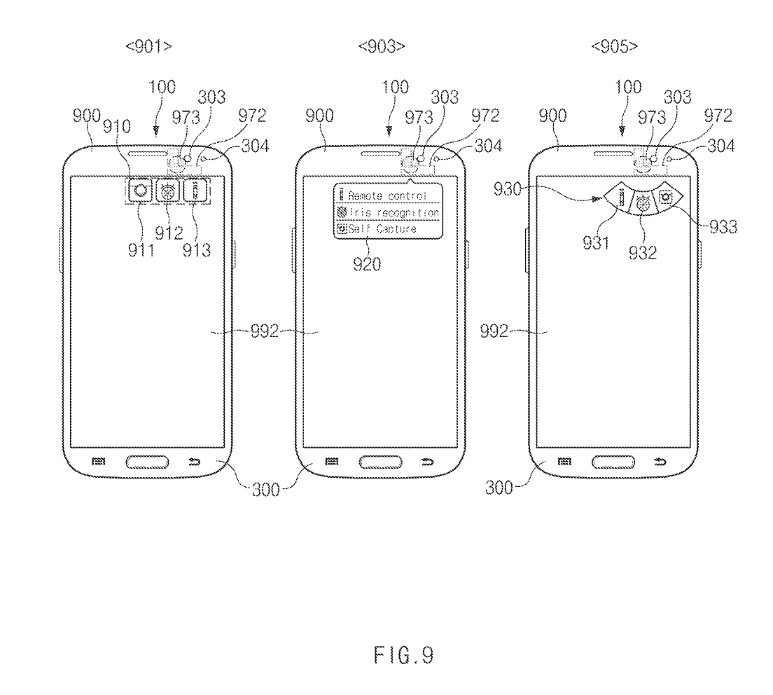

FIG. 9 is a diagram illustrating a shape of an object according to various embodiments of the present disclosure.

Referring to FIG. 9, the electronic device 100 according to various embodiments of the present disclosure may include a guard touch portion 972 disposed at a guard touch area 900 of the case 300. The guard touch portion 972 may be disposed adjacent to an area where image sensor 303 and proximity sensor 304 are disposed. According to an embodiment of the present disclosure, the guard touch portion 972 may be associated with output of an object including at least one function item related to the image sensor 303 and proximity sensor 304. The image sensor 303 and proximity sensor 304 may be the image sensor 303 and the proximity sensor 304 respectively.

According to various embodiments of the present disclosure, if a touch event 973 (or a hovering event) of touching the guard touch portion 972 occurs, the function processing module 170 of the electronic device 100 may output an object 910 to a specific screen 992 in response to the occurrence of the touch event 973 as shown in a state 901. The object 910 may include at least one icon. For example, the object 910 may have the shape of a box surrounding icons 911 to 913. Alternatively, the object 910 may include a certain area (e.g., a transparent area) including the icons 911 to 913. The icons 911 to 913 may include a function item (e.g., the icon 911) related to the image sensor 303, a function item (e.g., the icon 912) related to recognition of an eye or a pupil, or a remote control function item (e.g., the icon 913).

According to various embodiments of the present disclosure, if the touch event 973 related to the guard touch portion 972 occurs, the function processing module 170 may output an object 920 to a specific screen 992 as shown in a state 903. The object 920 may be a list type. The object 920 may have an image shaped to indicate the guard touch portion 972, the image sensor 303, or the proximity sensor 304. The object 920 may include at least one list item. For example, the object 920 may include a list item related to a remote control function, a list item related to recognition of an iris, or a list item related to a self camera.

According to various embodiments of the present disclosure, if the touch event 973 related to the guard touch portion 972 occurs, the function processing module 170 may output an object 930 to a specific screen 992 as shown in a state 905. The object 930 may be an image having a certain shape (e.g., a semicircular band). The object 930 may include one or more link items 931 to 933 (e.g., an image associated with execution of a set function upon selection of an item area). The link items may include the item 931 related to a remote control function, the item 932 related to recognition of an iris, or the item 933 related to a self camera function.

According to various embodiments of the present disclosure, the function processing module 170 may output various objects in response to selection of a guard touch portion related to a specific hardware component. For example, the function processing module 170 may output an object in which a plurality of icons or items are arranged in a matrix. Furthermore, the function processing module 170 may output an object in which at least a portion of a plurality of icons or items overlap each other. While the object in which items overlap each other is displayed, if a scroll event or a sweep event related to the object occurs, the function processing module 170 may replace an uppermost icon or item with another icon or item of which at least a part is hidden.

The specific screen 992 may be a lock screen, a home screen, a standby screen, or the like. Alternatively, the specific screen 992 may be an execution screen of a specific function. For example, the specific screen 992 may be a music playback screen.

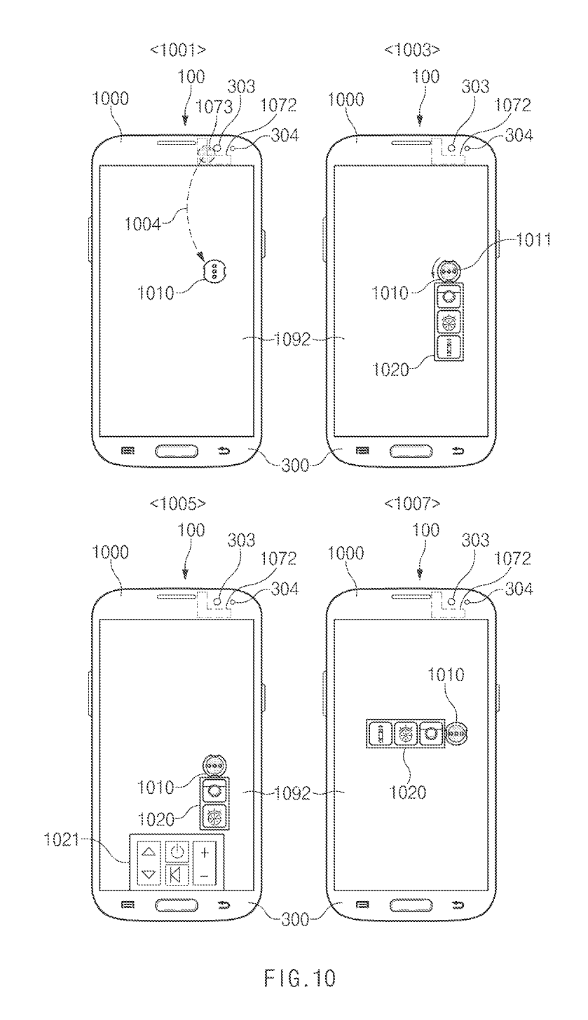

FIG. 10 is a diagram illustrating an object output and a function item output according to various embodiments of the present disclosure.

Referring to FIG. 10, the electronic device 100 according to various embodiments of the present disclosure may include a guard touch portion 1072 disposed at a guard touch area 1000 of the case 300. The guard touch portion 1072 may be disposed adjacent to an area where image sensor 303 and proximity sensor 304 are disposed. The guard touch portion 1072 may be associated with output of an object including at least one function item related to the image sensor 303 and proximity sensor 304. The image sensor 303 and proximity sensor 304 may be the image sensor 303 and the proximity sensor 304 (or an infrared sensor) respectively.

According to various embodiments of the present disclosure, if a touch event 1073 (or a hovering event) of touching the guard touch portion 1072 occurs, the function processing module 170 of the electronic device 100 may output an object 1010 to a specific screen 1092 in response to the occurrence of the touch event 1073 as shown in a state 1001. According to various embodiments of the present disclosure, if the touch event 1073 occurs, the function processing module 170 may output the object 1010 to a display area adjacent to an area where the guard touch portion 1072 or the image sensor 303 and proximity sensor 304 are disposed as shown in the state 1001. The object 1010 may include a specified certain image. According to various embodiments of the present disclosure, the object 1010 may include a certain image related to the number of set function items (e.g., circles related to the number of function items).

If a drag event 1004 of touching and dragging the object 1010 occurs, the function processing module 170 may adjust the position of the object according to the drag event 1004. According to an embodiment of the present disclosure, after the touch event 1073 occurs on the guard touch portion 1072 in response to a touch motion, the object 1010 displayed on a certain area of the display may be moved due to modification to the touch motion (e.g., a drag motion). The function processing module 170 may output the object 1010 to a specified certain location in response to the touch event 1073, and may move the object 1010 in response to a touch-and-drag motion on the display. Alternatively, the function processing module 170 may select an object to be output by the touch event 1073, and may allow the object 1010 to be displayed by a touch event that occurs on a display area.

According to various embodiments of the present disclosure, if a specific event 1011 related to the object 1010 (e.g., an event of selecting the object 1010 or an event of rotating the object 1010 in a certain direction) occurs, the function processing module 170 may output, to the screen 1092, a sub object 1020 including function items associated with the object 1010 as shown in a state 1003. The sub object 1020 may include, for example, a function item related to the image sensor 303, a function item related to recognition of an iris, a remote control function item, or the like. The sub object 1020 may include at least one image corresponding to the function items.

The screen 1092 may be a lock screen, a home screen, a standby screen, or the like. According to various embodiments of the present disclosure, the screen 1092 may be an execution screen of a function item related to the image sensor 303. Alternatively, the screen 1092 may be a screen related to execution of an iris recognition function or an execution screen of a remote control function. According to various embodiments of the present disclosure, the function processing module 170 may differently handle the sub object 1020 according to the type of a current screen. For example, in the case where the current screen 1092 includes a remote control function item 1021 as shown in a state 1005, the function processing module 170 may output the sub object 1020 including items (e.g., a function item related to an image sensor, a function item related to recognition of an iris, or the like) other than a remote control function item. For another example, in the case where the current screen 1092 is related to a specific function item (e.g., a function item related to the image sensor 303), the function processing module 170 may exclude a function item related to the image sensor 303 from the function items of the sub object 1020 when outputting the sub object 1020.

According to various embodiments of the present disclosure, if an event of moving the object 1010 in a specific direction (e.g., in an opposite direction to or the same direction as the rotating direction of the sub object 1020) by a specified distance, the function processing module 170 may remove the sub object 1020 from the display. According to various embodiments of the present disclosure, the function processing module 170 may not allow movement of the object 1010 (including the sub object 1020) while the sub object 1020 is displayed. Alternatively, if a specific event (e.g., an event of selecting and dragging the object 1010) occurs, the function processing module 170 may move and display the sub object 1020 and the object 1010 in response to the event.

According to various embodiments of the present disclosure, in the case where an area for displaying the sub object 1020 is insufficient (e.g., in the case where the entirety of the sub object 1020 is not able to be displayed since the object 1010 is disposed within a certain distance (or specific range) from the bottom of the screen 1092), the function processing module 170 may change an output direction of at least a part of the sub object 1020. For example, even if the at least one image included in the sub object 1020 is configured to be positioned at the right side of the object 1010, the function processing module 170 may perform control so that the sub object 1020 is positioned at the left side of the object 1010 as shown in a state 1007. As described above, the function processing module 170 may display the sub object 1020 at the left or right side or the top of the object 1010 according to a user-defined direction or a position of the object 1010 on the display.

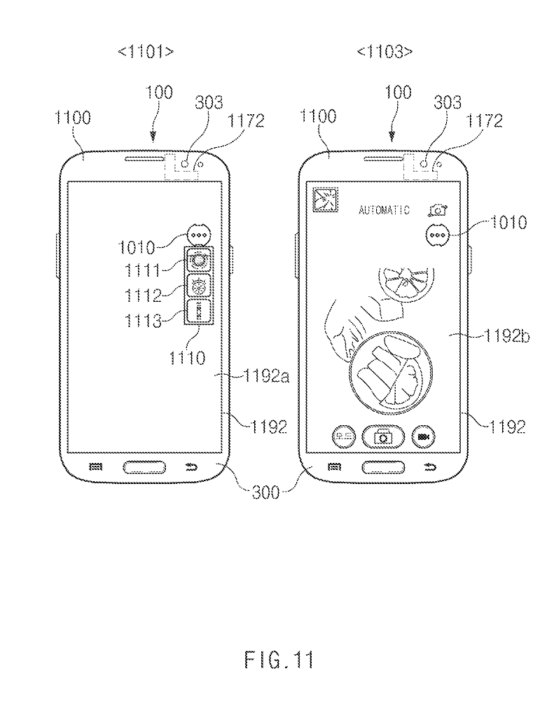

FIG. 11 is a diagram illustrating operation of a function item according to various embodiments of the present disclosure.

Referring to FIG. 11, according to various embodiments of the present disclosure, if an event occurs in relation to a guard touch portion 1172 adjacent to image sensor 303 (e.g., an image sensor) disposed at a certain portion of the guard touch area 1100 of the case 300, the function processing module 170 of the electronic device 100 may output the object 1010 to a display 1192 as shown in a state 1101. The display 1192 may output a screen 1192a. The screen 1192a may be a lock screen, a home screen, or an execution screen of a specific function (e.g., a music playback screen, a gallery screen, an instant message screen, or the like).

According to various embodiments of the present disclosure, the function processing module 170 may output a sub object 1110 together with the object 1010. Alternatively, the function processing module 170 may output the sub object 1110 when an event related to the object 1010 occurs. The sub object 1110 may include at least one function item (e.g., an image sensor function item 1111, an iris recognition function item 1112, or a remote control function item 1113).

If an event related to a specific function item included in the sub object 1110, for example, an event related to the image sensor function item 1111 (e.g., a touch event), occurs, the function processing module 170 may execute a function related to the function item. For example, the function processing module 170 may activate the image sensor 303, and may output, to the display 1192, a screen 1192b corresponding to the activation of the image sensor 303 and the function execution as shown in a state 1103. In an operation of changing the screen 1192a into the screen 1192b, the function processing module 170 may suspend displaying of the sub object 1110 (or remove the object 1110 from the screen 1192b).

According to various embodiments of the present disclosure, the function processing module 170 may maintain a display state of the object 1010 while outputting the screen 1192b. In relation to output of the screen 1192b, the function processing module 170 may move the object 1010 to a specified portion of the screen 1192b or may maintain the position of the object 1010 displayed on the previous screen 1192a. According to various embodiments of the present disclosure, the function processing module 170 may suspend displaying of the object 1010 and the sub object 1110 while outputting the screen 1192b in response to selection of a specific function item of the sub object 1110.

According to various embodiments of the present disclosure, if an event related to the object 1010 occurs on the screen 1192b, the function processing module 170 may output the sub object 1110 to an area adjacent to the object 1010 on the screen 1192b. When the event related to the object 1010 occurs, the function processing module 170 may output the sub object 1110 including function items (e.g., the function items 1112 and 1113) other than a function item related to the screen 1192b. Alternatively, the function processing module 170 may output the sub object 1110 as shown in the state 1101.

According to various embodiments of the present disclosure, if a function corresponding to the screen 1192b is terminated, the function processing module 170 may output the previous screen 1192a to the display 1192. As the screen 1192b is closed, the function processing module 170 may output at least one of the object 1010 or the sub object 1110 to the screen 1192a. Alternatively, the function processing module 170 may output the screen 1192a from which the object 1010 and the sub object 1110 are removed.

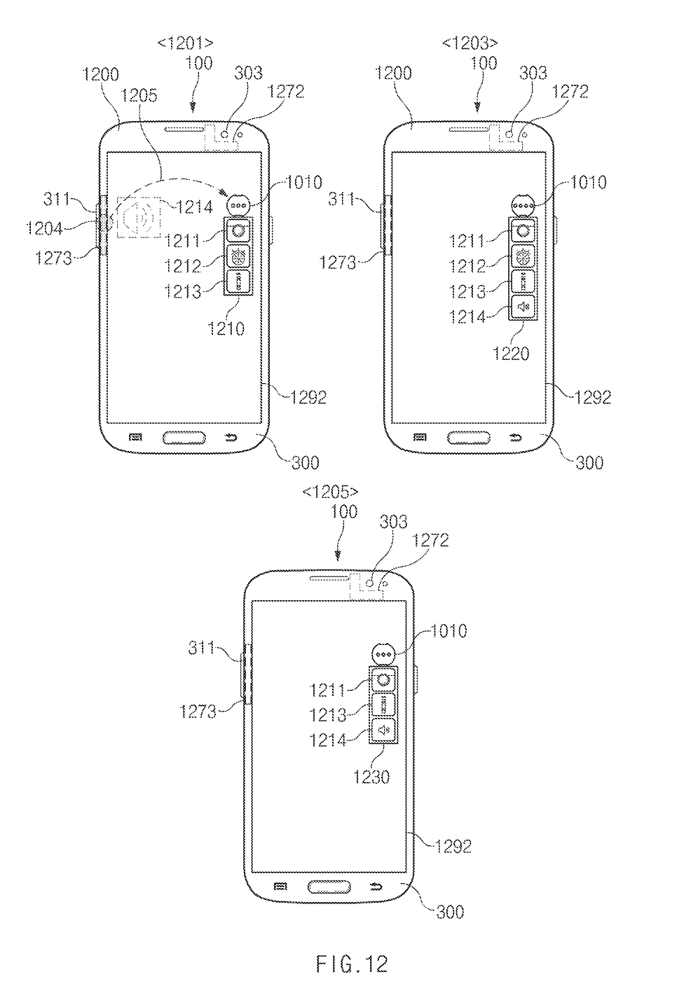

FIG. 12 is a diagram illustrating addition of a function item according to various embodiments of the present disclosure.

Referring to FIG. 12, according to various embodiments of the present disclosure, a guard touch area 1200 of the case 300 may include a guard touch portion 1272 disposed adjacent to the image sensor 303 (e.g., an image sensor) or the proximity sensor 304. The guard touch area 1200 of the case 300 may include a guard touch portion 1273 disposed adjacent to the physical key button 311.

If an event related to the guard touch portion 1272 occurs, the function processing module 170 of the electronic device 100 may output the object 1010 to a display 1292 as shown in a state 1201. The display 1292 may be currently outputting a lock screen, a home screen, or an execution screen of a specific function (e.g., a music playback screen, a gallery screen, an instant message screen, or the like). According to various embodiments of the present disclosure, the function processing module 170 may output a sub object 1210 together with the object 1010. Alternatively, the function processing module 170 may output the sub object 1210 when an event related to the object 1010 (e.g., an event of touching the object 1010) occurs. The sub object 1210 may include at least one function item (e.g., an image sensor function item 1211, an iris recognition function item 1212, or a remote control function item 1213). According to various embodiments of the present disclosure, in relation to output of a specific screen (e.g., a lock screen, a home screen, or the like), the function processing module 170 may automatically output the object 1010 related to the image sensor 303, proximity sensor 304, or the object 1010 including the sub object 1210.

If a touch event occurs on the guard touch portion 1072 related to the image sensor 303 or proximity sensor 304, the function processing module 170 may remove the object 1010 or the sub object 1210 from a screen of the display 1292. According to various embodiments of the present disclosure, the function processing module 170 may store information on a previous state of a specific screen (e.g., a state in which the object 1010 is displayed or a state in which the object 1010 is not displayed). The function processing module 170 may or may not output the object 1010 according to a previous state if output of a specific screen is required.

The function processing module 170 may receive at least one of an event 1204 occurring on the guard touch portion 1273 related to the physical key button 311 (e.g., an event of touching the guard touch portion 1273) or an event 1205 occurring on the display 1292 (e.g., a drag event of combining a certain area of the display 1292 with the object 1010). If the event 1204 is received, the function processing module 170 may output a function item 1214 related to the physical key button 311 to a certain area of the display 1292. The function item 1214 output in the state 1201 may have a display effect (e.g., a specified transparency, a specified color, or the like) different from that of the function item 1214 displayed on a sub object 1220 in a state 1203. The function processing module 170 may move and display the function item 1214 on the display 1292 in response to the event 1205. According to various embodiments of the present disclosure, the function processing module 170 may skip output of the function item 1214 having a specific display effect in response to the event 1204 or 1205.

If an event of touching the guard touch portion 1273 at which the physical key button 311 is disposed and then sliding to an area of the display 1292 where the object 1010 is disposed occurs, the function processing module 170 may output the sub object 1220 as shown in the state 1203. The sub object 1220 may include the function item 1214 related to the physical key button 311 in addition to the function items 1211 to 1213 included in the sub object 1210. As described above, the function processing module 170 may support addition of a function item related to a specific hardware component in response to occurrence of a specific event. By virtue of the function of adding a function item, the object 1010 may be output if an event related to the guard touch portion 1272 or an event related to the guard touch portion 1273 occurs. A location to which the object 1010 to which a function item has been added is output may be a display area adjacent to at least one of the guard touch portion 1272 or the guard touch portion 1273.

According to various embodiments of the present disclosure, if an event related to a specific function item (e.g., the function item 1212) included in the sub object 1220 occurs (e.g., if an event of selecting the function item 1212 and dragging it in a specified direction occurs), the function processing module 170 may display a sub object 1230 from which the function item 1212 is excluded as shown in a state 1205. According to various embodiments of the present disclosure, in the case where the functions items 1211 to 1213 are removed from the sub object (or in the case where only the function item 1214 related to the guard touch portion 1273 remains), the function processing module 170 may output the object 1010 in response to occurrence of an event related to the guard touch portion 1273.

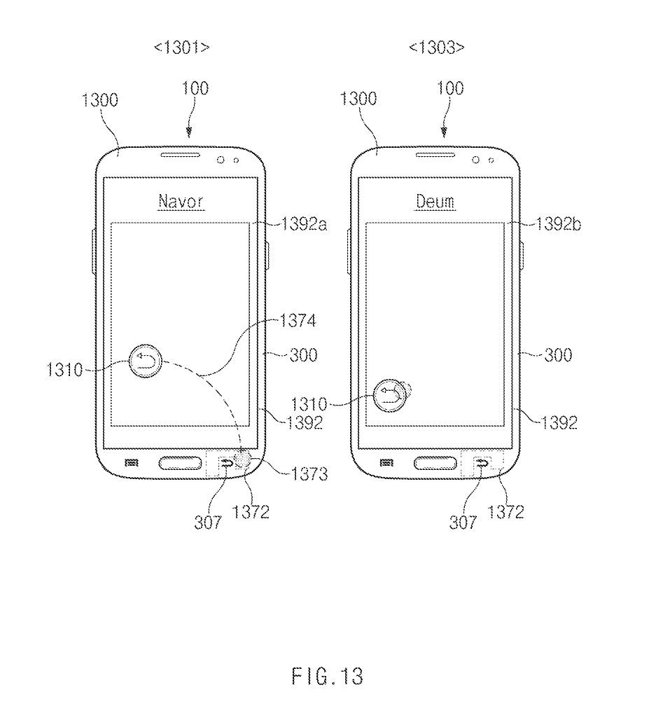

FIG. 13 is a diagram illustrating operation of a specific object according to various embodiments of the present disclosure.

Referring to FIG. 13, according to various embodiments of the present disclosure, a guard touch area 1300 of the case 300 may include a guard touch portion 1372 disposed adjacent to the physical key 307 (e.g., a physical key, a back key, or a touch key). The function processing module 170 may receive an event 1373 related to the guard touch portion 1372 (e.g., an event of touching the guard touch portion 1372) or an event 1374 occurring on a display 1392 (e.g., an event of dragging a certain area of the display 1392). In response to the event 1373, the function processing module 170 may output a specified object (e.g., to a certain area of the display 1392 adjacent to the physical key 307) as shown in a state 1301. Furthermore, the function processing module 170 may change a display position of an object 1310 in response to the event 1374. The display 1392 may output a specific screen 1392a. The specific screen 1392a may be a server page screen displayed due to access to a specific server device. The function processing module 170 may output the object 1310 to a layer differentiated from that of the specific screen 1392a. According to an embodiment of the present disclosure, the object 1310 may include an image related to the physical key 307 (e.g., a back key image).

According to various embodiments of the present disclosure, the function processing module 170 may perform a specified function in response to occurrence of an event related to the object 1310 (e.g., a touch event of touching the object 1310) as shown in a state 1303. For example, if an event related to the object 1310 occurs, the function processing module 170 may display a previous screen or a next screen 1392b on the display 1392. According to various embodiments of the present disclosure, when an event related to the object 1310 occurs, the function processing module 170 may close the screen 1392a of the state 1301.

According to various embodiments of the present disclosure, the function processing module 170 may continue to display the object 1310 while the screen 1392a is closed and the screen 1392b is displayed. Alternatively, the function processing module 170 may automatically remove the object 1310 if all of functions being executed (e.g., a plurality of sever page screens, a plurality of function execution screens, or the like) are terminated when the object 1310 is output. Alternatively, the function processing module 170 may remove the object 1310 if a specified screen (e.g., a home screen or the like) is output to the display 1392.

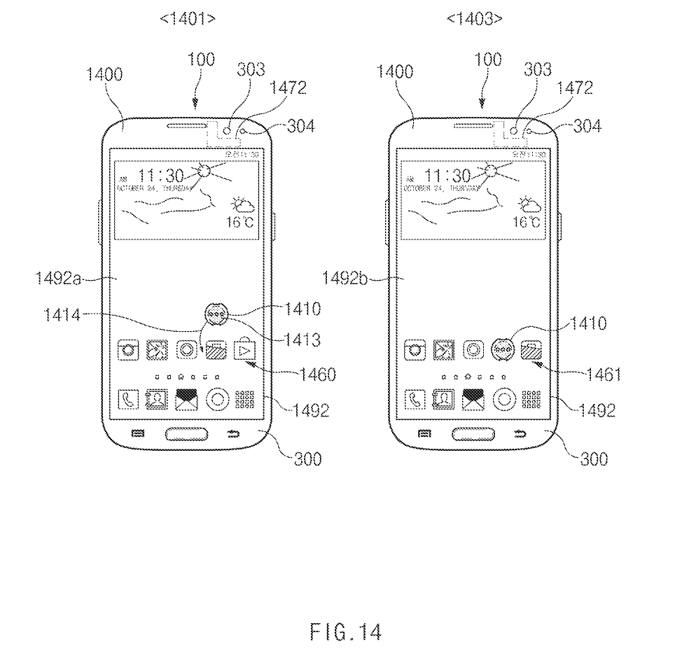

FIG. 14 is a diagram illustrating adjustment of a position of an object according to various embodiments of the present disclosure.

Referring to FIG. 14, according to various embodiments of the present disclosure, if a touch event or the like occurs on a guard touch portion 1472 related to a specific hardware component disposed at a guard touch area 1400 of the case 300, the function processing module 170 may output an object 1410 to a display 1492. For example, as shown in a state 1401, the function processing module 170 may output the object 1410 to the display 1492 on which a screen 1492a is displayed. An output position of the object 1410 may be a display area adjacent to an area where a specific hardware component is disposed. If an event related to movement of the object 1410 occurs, the function processing module 170 may change the position of the object 1410 on the screen 1492a in response to the event. The screen 1492a may include an arrangement 1460 of specific screen elements, for example, at least one widget or at least one icon.

The function processing module 170 may receive an event related to the object 1410 (e.g., a touch event 1413 of selecting the object 1410 and a drag event 1414 of moving the object 1410). If an event related to movement of the object 1410 occurs, the function processing module 170 may insert the object 1410 into the arrangement 1460 so as to provide a new arrangement 1461 of screen elements as shown in a state 1403. Accordingly, the screen 1492a may be changed into a screen 1492b including the new arrangement 1461.

According to various embodiments of the present disclosure, the function processing module 170 may provide a menu item or an icon related to entry into the object editing mode. Alternatively, the function processing module 170 may perform entry into the object editing mode in response to occurrence of a specified input event (e.g., an event of long-pressing a home button). The function processing module 170 may change a screen in response to entry into the object editing mode. For example, the function processing module 170 may output the object 1410 to a layer differentiated from that of the screen 1492a. In the case of entering the object editing mode, the function processing module 170 may disposed the object 1410 in the same layer as that of the screen 1492a. According to various embodiments of the present disclosure, if the disposition of the object 1410 on a screen is completed (e.g., obtaining the arrangement 1461 including the object 1410), the function processing module 170 may automatically terminate the object editing mode. If the disposition of the object 1410 on a screen is completed, the function processing module 170 may dispose the object 1410 in the same layer as that of the screen 1492b. According to various embodiments of the present disclosure, in the case where the object 1410 is generated in relation to a back key, the function processing module 170 may perform the same function as that of the back key when an event related to the object 1410 occurs.

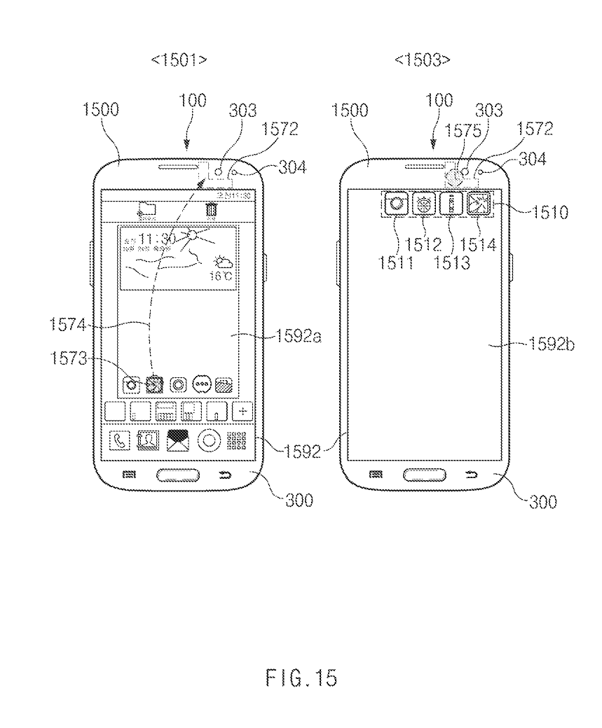

FIG. 15 is a diagram illustrating an object editing function according to various embodiments of the present disclosure.

Referring to FIG. 15, according to various embodiments of the present disclosure, a specific hardware component (e.g., the image sensor 303 or proximity sensor 304) and a guard touch portion 1572 related to the image sensor 303 or proximity sensor 304 may be disposed at a guard touch area 1500 of the case 300. The guard touch portion 1572 may be disposed at an upper part or a lower part of the case 300. When a specified event (e.g., an event of selecting an icon or a menu related to entry into the object editing mode or selecting a specific physical key button) occurs, the function processing module 170 may output an object editing screen 1592a to a display 1592 as shown in a state 1501. The object editing screen 1592a may include at least one function item. The at least one function item may include a function item related to at least one hardware component disposed at the guard touch area 1500. For example, the at least one function item may include at least one function item related to an audio jack, at least one function item related to a speaker, at least one function item related to an image sensor, at least one function item related to a communication antenna, or at least one function item related to a physical key or a physical key button.

According to various embodiments of the present disclosure, if an event related to a guard touch portion adjacent to a specific hardware component occurs, the function processing module 170 may output at least one function item related to the hardware component. For example, when a guard touch portion adjacent to a home button is selected, the function processing module 170 may output at least one function item related to the home button to the screen 1592a. When a guard touch portion adjacent to a back key is selected, the function processing module 170 may output at least one function item related to the back key to the screen 1592a. According to various embodiments of the present disclosure, when a plurality of guard touch portions adjacent to a plurality of hardware components are selected, the function processing module 170 may output function items related to the plurality of hardware components to the screen 1592a. In this operation, the function processing module 170 may provide a display effect or may arrange the function items so that the function items for each hardware component are differentiated from each other.

According to various embodiments of the present disclosure, the function processing module 170 may receive an event 1574 of selecting a specific function item 1573 and then moving it towards the guard touch portion 1572. As the event 1574 occurs, the function processing module 170 may output, to the display 1592, an object editing result screen 1592b as shown in a state 1503. For example, the function processing module 170 may output an object 1510 related to the image sensor 303 or proximity sensor 304 or the guard touch portion 1572 to a certain area (e.g., a display area adjacent to the image sensor 303 or proximity sensor 304). While outputting the object 1510, the function processing module 170 may add a function item 1514 corresponding to the function item 1573 to the object 1510. For example, the object 1510 may include function items 1511 to 1513 prior to the state 1501. Through the state 1501, the function item 1514 corresponding to the function item 1573 may be added to the object 1510. The function item 1514 may be a gallery function item. The gallery function item may be related to the image sensor 303 (e.g., the image sensor 303). According to various embodiments of the present disclosure, the function processing module 170 may add all function items providable by the electronic device 100 to the object editing screen 1592a to output the object editing screen 1592a. Alternatively, the function processing module 170 may provide function items of a screen being output to the display 1592 as function times for editing an object at the time of occurrence of an event related to object editing.

The term “module” used herein may represent, for example, a unit including one or more combinations of hardware, software and firmware. The term “module” may be interchangeably used with the terms “unit”, “logic”, “logical block”, “component” and “circuit”. The “module” may be a minimum unit of an integrated component or may be a part thereof. The “module” may be a minimum unit for performing one or more functions or a part thereof.

According to various embodiments of the present disclosure, at least a part of devices (e.g., modules or functions thereof) or methods (e.g., operations) according to various embodiments of the present disclosure may be implemented as instructions stored in a computer-readable storage medium in the form of a programming module. In the case where the instructions are performed by at least one processor, the at least one processor may perform functions corresponding to the instructions.

The computer-readable storage medium may include magnetic media such as a hard disk, a floppy disk, and a magnetic tape, optical media such as a compact disk-read only memory (CD-ROM) and a digital versatile disc (DVD), magneto-optical media such as a floptical disk, and a hardware device configured to store and execute program instructions (e.g., a programming module), such as a ROM, a random access memory, and a flash memory. The program instructions may include machine language codes generated by compilers and high-level language codes that can be executed by computers using interpreters. The above-mentioned hardware may be configured to be operated as one or more software modules for performing operations of various embodiments of the present disclosure and vice versa.

According to various embodiments of the present disclosure, a storage medium stores instructions configured to instruct at least one processor to perform at least one operation when being executed by the at least one processor, the at least one operation including receiving an input event at a guard touch area disposed within a certain distance (or specific range) from at least one hardware component disposed in an area other than an area of a display and outputting an object associated with the hardware component to the display according to the input event that has occurred on the guard touch area.

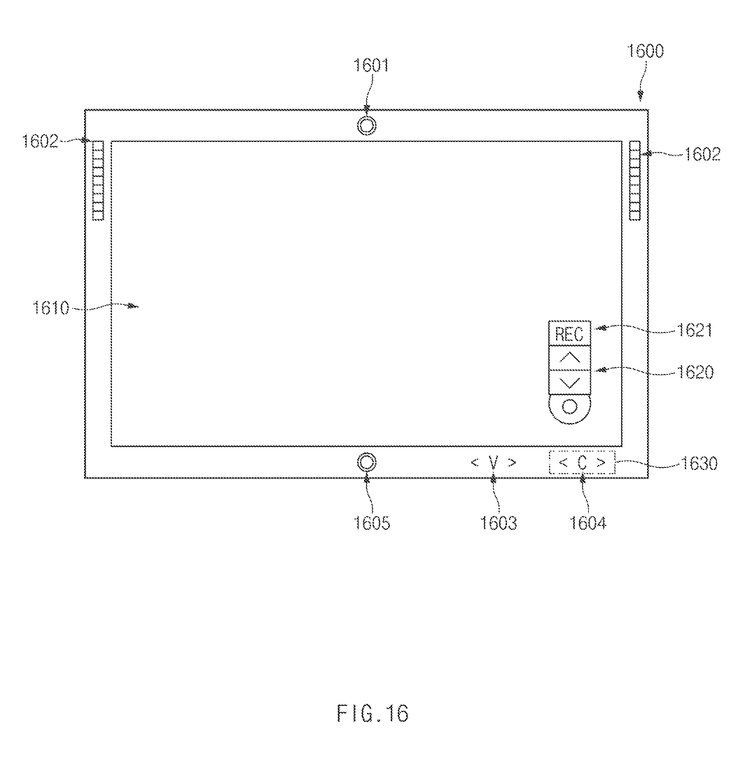

FIG. 16 is a diagram illustrating another example of output of a specified object for each hardware component information according to an embodiment of the present disclosure.

Referring to FIG. 16, an electronic device for outputting a function operating object for each hardware component information may be a monitor device 1600 that supports a touch function on a display area. The monitor device 1600 may include hardware components such as a physical volume control button 1603, a physical channel control button 1604, a camera 1601, a speaker 1602, a physical power button 1605, and the like. The monitor device 1600 may include guard touch areas arranged at an area adjacent to a specific hardware component (e.g., an area able to be touched at the same time when a hardware component is touched). If a guard touch area 1630 related to the physical channel control button 1604 is touched, the monitor device 1600 may output a channel control object 1620 for performing channel control to a display area 1610 of the monitor device 1600. According to an embodiment of the present disclosure, the monitor device 1600 may output the channel control object 1620 to a display area adjacent to an area where the physical channel control button 1604 is disposed. A user may perform channel control by controlling the channel control object (e.g., touching the channel control object) output to a display area.

According to various embodiments of the present disclosure, if a guard touch area adjacent to the physical channel control button 1604 is touched, the monitor device 1600 may output, to the display area 1610, a recording object 1621 related to a scheduled recording function or a recorded content viewing function, according to a setting. Mapping of the recording object to the guard touch area adjacent to the physical channel control button 1604 may be controlled by a user setting. According to various embodiments of the present disclosure, the electronic device may be a laptop computer.

According to various embodiments of the present disclosure, the electronic device may output the above-mentioned object in response to occurrence of a specified touch motion. For example, the electronic device may output the object when a first touch occurs on an area adjacent to a specific hardware component or a second touch occurs on a display area adjacent to the hardware component. According to an embodiment of the present disclosure, if the second touch (or a touch-and-drag event) occurs on the display area due to a motion of touching an area adjacent to a specific hardware component and then dragging, the electronic device may output an object corresponding to the hardware component. In relation to this operation, if a touch event occurs on the area adjacent to the hardware component, the electronic device may check a touch location, and then, if a touch-and-drag event occurs on the adjacent display area within a specified time, the electronic device may output the object corresponding to the hardware component. Therefore, if the user desires to control an operating object related to a specific hardware component (e.g., a camera) in a display area, the user may touch the specific hardware component or a periphery area thereof, and then may make a motion of dragging towards the display area. The electronic device may output the object corresponding to the hardware component to a touch portion on the display area. If a touch release occurs while a specific function item of the object is selected, the electronic device may handle execution of a function corresponding to the function item.

Although it has been described that a touch motion is made to select a hardware component, various embodiments of the present disclosure are not limited thereto. For example, the electronic device may operate an input unit for specifying or indicating a specific hardware component. According to an embodiment of the present disclosure, the electronic device may perform output of an object according to a voice input. For example, the electronic device may activate a microphone and may collect a voice signal. The electronic device may collect a specified voice input such as “camera” or “object operating camera”. The electronic device may output, to a display area adjacent to a camera, an operating object corresponding to the voice input.

According to various embodiments of the present disclosure, a monitor device (or a laptop computer) according to an embodiment of the present disclosure may include a display area configured to output at least one object and support a touch function related to manipulation of the object, at least one hardware component disposed outside the display area, and a processor configured to output, to the display area, an object associated with manipulation or operation of the at least one hardware component, upon receiving an input event indicating the at least one hardware component.

According to various embodiments of the present disclosure, a monitor device (e.g., a TV monitor, a personal computer (PC) monitor, an outdoor billboard, an indoor billboard, a display device of a movable device (a power device or a non-power device), or the like) according to an embodiment of the present disclosure may include a memory for storing at least one object related to manipulation of a hardware component and a processor connected to the memory, wherein the processor may output an object associated with the manipulation of the hardware to a display area when an input event indicating the hardware is received.

The processor may output an object to the display area that supports a touch function, the object being related to a hardware component indicated by information transferred through a touch input, a voice input, or a specific frequency. The object related to the manipulation of the hardware component may include a virtual button corresponding to a function supported by the hardware component.

Alternatively, the object related to the manipulation of the hardware component may include a button provided to execute at least one function by the hardware component. For example, the object may include a virtual channel control button corresponding to a physical channel control button. The object may include a virtual camera control button (e.g., a virtual button for manipulating image shooting conditions) corresponding to a camera.

According to various embodiments of the present disclosure, various functions related to a hardware component may be easily understood and used by a user.

Furthermore, according to various embodiments of the present disclosure, function operation related to a hardware component may be controlled at a location desired by the user.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A mobile electronic device comprising:
a display configured to display at least one object;
at least one hardware component disposed in an area other than an area of the display;
a guard touch area disposed within a distance from the at least one hardware component, wherein a touch event is generated when the guard touch area is touched; and
a processor configured to control the display to display an object associated with operation of one or more of the at least one hardware component based on the touch event.

2. The mobile electronic device of claim 1, wherein the at least one hardware component comprises at least one of an audio jack, at least one sensor, at least one physical key or physical key button, a speaker, an antenna, a connection port, or an electronic pen.

3. The mobile electronic device of claim 1, wherein the guard touch area is extended in series to a touch pattern disposed in the display or is disposed in parallel within a certain area.

4. The mobile electronic device of claim 1, wherein the guard touch area is disposed in at least one of a bezel surrounding an edge of the display, a side part connected to the bezel, or a rear part connected to the side part.

5. The mobile electronic device of claim 1, wherein the processor is further configured to:
control the display to display an object that supports input of an event for requesting execution of at least one function related to the at least one hardware component, or
control the display to display an object including a function item or an item for requesting execution of the at least one function related to the at least one hardware component.

6. The mobile electronic device of claim 5, wherein the processor is further configured to control the display to differently display at least one of a shape of the object or a type of a function item included in the object according to hardware state information related to operation of the at least one hardware component.

7. The mobile electronic device of claim 6, wherein the processor is further configured to collect, as the hardware state information, at least one of information indicating whether an external device is connected to an audio jack, information indicating whether an external device is connected to a connection port, information indicating whether a sensor is active or inactive, information indicating whether an antenna is operated, information indicating whether a speaker displays audio data, or information indicating whether an electronic pen is operated.

8. The mobile electronic device of claim 5, wherein the processor is further configured to provide a menu or a screen related to editing of a shape of the object or at least one function item included in the object according to the touch event.

9. The mobile electronic device of claim 5, wherein the processor is further configured to:
remove the at least one function item from the object, or
add a new function item thereto according to the touch event.

10. The mobile electronic device of claim 5, wherein the processor is further configured to:
control the display to display the object in a display area adjacent to at least one hardware component related to a corresponding function, and
adjust a position of the object or fixe the object to a screen on which the object is displayed according to the touch event.

11. An input supporting method comprising:
receiving a touch event at a guard touch area disposed within a distance from at least one hardware component disposed in an area other than an area of a display of a mobile electronic device; and
displaying on the display an object associated with operation of one or more of the at least one hardware component based on the touch event.

12. The input supporting method of claim 11, wherein the wherein the at least one hardware component comprises at least one of an audio jack, at least one sensor, at least one physical key or physical key button, a speaker, an antenna, a connection port, or an electronic pen.

13. The input supporting method of claim 11, wherein the guard touch area is disposed in at least one of a bezel, a side part connected to the bezel, or a rear part connected to the side part, the bezel being extended in series to a touch pattern disposed in the display or being disposed in parallel within a certain area, or the bezel surrounding an edge of the display.

14. The input supporting method of claim 11, wherein the displaying on the display comprises at least one of:
displaying on the display an object that supports input of an event for requesting execution of at least one function related to the at least one hardware component; or
displaying on the display an object including a function item or an item for requesting execution of the at least one function related to the at least one hardware component.

15. The input supporting method of claim 14, further comprising:
collecting hardware state information related to operation of the at least one hardware component; and
differently displaying on the display at least one of a shape of the object or a type of a function item included in the object according to the hardware state information.

16. The input supporting method of claim 15, wherein the collecting comprises collecting at least one of information indicating whether an external device is connected to an audio jack, information indicating whether an external device is connected to a connection port, information indicating whether a sensor is active or inactive, information indicating whether an antenna is operated, information indicating whether a speaker outputs audio data, or information indicating whether an electronic pen is operated.

17. The input supporting method of claim 14, further comprising displaying on the display a menu or a screen related to editing of a shape of the object or at least one function item included in the object according to the touch event.

18. The input supporting method of claim 14, further comprising removing the at least one function item from the object or adding a new function item thereto according to the touch event.

19. The input supporting method of claim 14, further comprising adjusting a position of the object or fixing the object to a certain portion of a displayed screen or the display according to the touch event.

20. The input supporting method of claim 14, wherein the displaying comprises displaying the object in a display area adjacent to at least one hardware component related to a corresponding function.
